(19) United States
(12) Patent Application Publication
(10) Pub. No.: US 2021/0243554 A1
(43) Pub. Date: Aug. 5, 2021

(54) TECHNIQUES FOR DISTANCE BASED SIDELINK TRANSMISSION

(71) Applicant: QUALCOMM Incorporated, San Diego, CA (US)

(72) Inventors: Shuanshuan WU, San Diego, CA (US); Sudhir Kumar BAGHEL, Hillsborough, NJ (US); Shailesh PATIL, San Diego, CA (US); Gabi SARKIS, San Diego, CA (US); Kapil GULATI, Belle Mead, NJ (US)

(21) Appl. No.: 17/151,026

(22) Filed: Jan. 15, 2021

Related U.S. Application Data
(60) Provisional application No. 62/968,089, filed on Jan. 30, 2020.

(51) Int. Cl. H04W 4/02; H04W 72/04; H04W 4/40; H04B 17/318; H04W 72/12

(52) U.S. Cl. CPC H04W 4/023; H04W 72/0406; H04W 72/1242; H04B 17/318; H04W 4/40

(57) ABSTRACT

A method of triggering a distance-based feedback transmission in a vehicle communication system includes determining an availability of the location information of a first electronic device, and transmitting sidelink control information that indicates the availability of the location information of the first electronic device. The sidelink control information includes a communication range indication or another parameter indicating the availability of the location information of the first electronic device. A receiving device receives the sidelink control information from the first electronic device, determines based on the sidelink control information that the location information of the first electronic device is unavailable, and transmits a distance-based feedback message to the first electronic device based at least in part on the sidelink control information.

### CROSS-REFERENCES TO RELATED APPLICATIONS

This patent application claims benefit of and priority to U.S. Provisional Patent Application Ser. No. 62/968,089, filed Jan. 30, 2020, entitled “Techniques For Distance Based Sidelink Transmission,” which is assigned to the assignee hereof and is hereby incorporated by reference in its entirety for all purposes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, or even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. One area of interest for further development in 5G NR and other communication standards (e.g., LTE) is device-to-device (D2D) communications, which may include vehicle-to-everything (V2X) communications, such as vehicle-to-vehicle (V2V) communications. In D2D communications, devices may communicate directly with each other via sidelink communications.

Vehicle-to-everything (V2X) is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly-termed road-side units (RSUs)), vehicle-to-person (V2P) communication between vehicles and nearby people (e.g., pedestrians, cyclists, and other road users), and the like. Further, V2X can use any of a variety of wireless radio frequency (RF) communication technologies. Cellular V2X (CV2X), for example, is a form of V2X that uses cellular-based communication such as long-term evolution (LTE), fifth generation new radio (5G NR), and/or other cellular technologies in a direct-communication mode as defined by the 3rd Generation Partnership Project (3GPP). A component or device on a vehicle, RSU, or another V2X entity that is used to communicate V2X messages is generically referred to as a V2X device or V2X user equipment (UE).

Location information for the UEs can be used for various applications for V2X system. V2X communications may use location data provided by navigation signals for certain V2X applications. One application can be for calculating the transmitter to receiver distance for knowing whether feedback information should be transmitted. Under certain circumstances, location information may be unavailable. This can be due to, for example, blockages of navigation signals (e.g., in tunnels or dense urban areas) or navigation system malfunctions, or navigation signal interference. Thus, it is possible that location information is unavailable to a transmitter UE, a receiver UE, or both the transmitter and receiver UEs.

Vehicle communication systems require techniques to communicate to other V2X devices that the location information of the UE is unavailable using existing or planned V2X communications protocols.

### BRIEF SUMMARY

Techniques described herein provide for communicating information indicating that navigation information of a vehicle-to-everything (V2X) device is unavailable to a receiver device. The techniques can transmit sidelink information using existing or proposed V2X communications protocols. In some embodiments, the V2X communications protocol can be modified to indicate the availability or unavailability of the location information of a first V2X user equipment (UE). The sidelink control information can be communicated to a second V2X UE. Upon receiving the sidelink control information with the information regarding the availability of the location information of the first V2X UE, the second V2X UE can determine whether a feedback signal should be transmitted, based at least in part on the sidelink control information.

According to certain embodiments, a method of triggering a distance-based feedback transmission in a vehicle communication system may include determining an availability of location information of a first electronic device, and transmitting sidelink control information that indicates the availability of the location information of the first electronic device.

In some embodiments, the sidelink control information may include a communication range indication that indicates the availability of the location information of the first electronic device. The method may include setting the communication range indication to a predetermined value based on determining that the location information of the first electronic device is unavailable. The predetermined value may indicate a predetermined communication range that is lower than a first threshold value or greater than a second threshold value. Alternatively, the predetermined value may be a reserved value indicating that the location information of the first electronic device is unavailable.

In some embodiments, the sidelink control information may include one or more parameters indicating the availability of the location information of the first electronic device. The one or more parameters may include a parameter dedicated to indicating whether the location information of the first electronic device is available, or may include a parameter that indicates whether the location information of the first electronic device is available and whether the distance-based feedback transmission is enabled.

In some embodiments, the sidelink control information may include a communication range indication that indicates a communication range greater than a threshold range value, and a randomly selected zone identification (ID) or a predetermined zone ID for indicating an unavailability of the location information of the first electronic device. In some embodiments, the sidelink control information may include at least one of a parameter indicating a priority of a sidelink data channel associated with the sidelink control information, or a parameter indicating whether the distance-based feedback transmission is requested.

According to certain embodiments, a V2X device may include a transceiver, a memory, and one or more processing units communicatively coupled with the transceiver and the memory and configured to perform, directly or via the transceiver, any of the above-described methods and operations.

According to certain embodiments, a method may include receiving, from a first device, sidelink control information by a second device, determining that location information of the first device is unavailable based on the sidelink control information, and transmitting a distance-based feedback message to the first device based at least in part on the sidelink control information.

In some embodiments, the sidelink control information may indicate that the distance-based feedback message is requested regardless of a distance between the first device and the second device. Thus, the second device may send the distance-based feedback message without considering the distance between the first device and the second device. In some embodiments, the method may include measuring a refence signal received power (RSRP) value of a reference signal from the first device, and transmitting the distance-based feedback message in response to at least one of the RSRP value exceeding an RSRP threshold value or the sidelink control information indicating that the distance-based feedback message is requested.

In some embodiments, the method may include determining, from the sidelink control information, a priority value of a sidelink data channel associated with the sidelink control information, and transmitting the distance-based feedback message in response to at least one of the priority value exceeding a priority threshold value or the sidelink control information indicating that the distance-based feedback message is requested. In some embodiments, the method may include determining, based on a communication range indication in the sidelink control information, a communication range of the first device, and transmitting the distance-based feedback message in response to at least one of the communication range exceeding a range threshold value or the sidelink control information indicating that the distance-based feedback message is requested.

According to certain embodiments, a V2X device may include a transceiver, a memory, and one or more processing units communicatively coupled with the transceiver and the memory and configured to perform, directly or via the transceiver, any of the above-described methods and operations.

These and other embodiments are described in detail below. For example, other embodiments are directed to systems, devices, and computer readable media associated with the methods described herein.

A better understanding of the nature and advantages of embodiments of the present disclosed may be gained with reference to the following detailed description and the accompanying drawings.

### BRIEF DESCRIPTION OF THE DRAWINGS

FIG. 1 is a diagram illustrating an example of a wireless communication system and an access network in accordance with various aspects of the present disclosure.

FIGS. 2A, 2B, 2C, and 2D illustrate examples of a downlink (DL) frame structure, DL channels within the DL frame structure, an uplink (UL) frame structure, and UL channels within the UL frame structure, respectively.

FIG. 3 illustrates an example of a base station and user equipment (UE) in an access network in accordance with various aspects of the present disclosure.

FIG. 4 is a diagram of an example of a wireless communication system in accordance with various aspects of the present disclosure.

FIG. 5 is a diagram illustrating an example of a sidelink communication structure in accordance with various aspects of the present disclosure.

FIG. 6 is a diagram illustrating examples of sidelink communication structures in accordance with various aspects of the present disclosure.

FIG. 7 is a diagram illustrating an example of a sidelink communication structure having at least one feedback symbol in accordance with various aspects of the present disclosure.

FIG. 8 is a diagram illustrating wireless communications in a traffic environment in accordance with various aspects of the present disclosure.

FIG. 9 illustrates a process flow for triggering feedback responses in the absence of location data in vehicle-to-everything (V2X) communications according to certain embodiments.

FIG. 10 includes a flow diagram illustrating a method for triggering distance-based V2X feedback responses in the absence of location data according to certain embodiments.

FIG. 11 includes a flow diagram illustrating a method for issuing feedback responses in the absence of location data according to certain embodiments.

FIG. 12 is a simplified block diagram of a basic architecture including components for V2X communications according to certain embodiments.

FIG. 13 is a simplified block diagram of an example of a V2X device according to certain embodiments.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As referred to herein, “V2X devices,” “V2X vehicles,” and “V2X entities” respectively refer to devices, vehicles, and entities capable of transmitting and receiving V2X messages. Similarly, “non-V2X vehicles” and “non-V2X entities” refer to vehicles and entities that do not or cannot engage in V2X communications. Although many embodiments described “V2X vehicles” and “non-V2X vehicles,” it will be understood that many embodiments can be expanded to include non-vehicle entities, such as pedestrians, cyclists, road hazards, obstructions, and/or other traffic-related objects etc. As generally referred to herein, the “objects” detected by sensors as described in the embodiments herein may refer to detected vehicles or non-vehicle objects, which may be on or near the road. Additionally, although embodiments herein are directed toward V2X enhanced navigation techniques, it will be understood that alternative embodiments may be directed toward alternative forms of traffic-related communication. A person of ordinary skill in the art will appreciate such variations.

In V2X communication, data transmitted by one V2X device may be relevant only to V2X devices within a certain distance of the transmitting V2X device. For example, vehicles attempting to traverse an intersection may only find data relevant within a certain proximity to the intersection. Similarly, for vehicles participating in coordinated driving, only vehicles affected by a maneuver may find the data relevant.

As noted, V2X (under 5G NR) supports distanced-based communication control. More specifically, if a receiving V2X device within a specified distance (referred to herein as the “V2X communication range” or simply “communication range”) receives a V2X message from a transmitting V2X device, the receiving V2X device will transmit a negative acknowledgement (NAK) if it is within the specified range, but has failed to decode the message. This allows the transmitting V2X device to retransmit the message. Through this mechanism, the reception reliability of V2X is increased for V2X devices within the specified range, enhancing performance for device maneuvers relying on the underlying V2X communication.

Additionally, V2X-capable devices may be knowledgeable of the location and motion state of other V2X vehicles, as well as non-V2X vehicles (and other objects) in their vicinity. For the former, the knowledge may be gained by reception of message or signaling from other V2X devices, for example, control signaling indicating V2X device's or vehicle's location, Basic Safety Message (BSM), or Cooperative Awareness Message (CAM). For the latter, the knowledge may be gained, for example, by on-board sensors capable of detecting the motion state and/or other properties of the non-V2X vehicles and other objects.

Embodiments provided herein leverage the ability of a V2X device to use on-board sensors to determine properties of non-V2X vehicles and other objects to dynamically determine a communication range for a V2X message. In some embodiments, for example, a V2X device can determine one or more properties of a detected object and increase the communication range for a V2X message based on the one or more properties, to help inform nearby V2X devices of the one or more properties of the detected object. This additional information can alert nearby V2X devices of any conditions that made need to be taken into account to ensure user safety. Embodiments are described below, in reference to the accompanying figures.

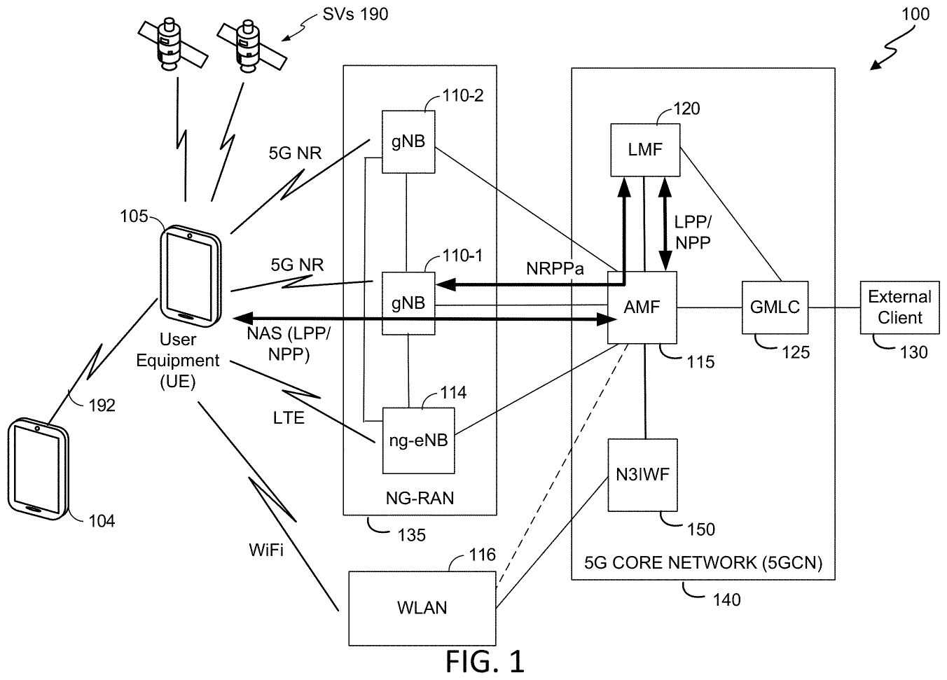

FIG. 1 shows a diagram of a communication system 100, according to an embodiment. The communication system 100 may be configured to determine the location of a UE 105 by using access nodes 110, 114, 116 and/or a location management function server (LMF 120) to implement one or more positioning methods. Here, the communication system 100 comprises a UE 105, and components of a 5G network comprising a Next Generation (NG) Radio Access Network (RAN) (NG-RAN) 135 and a 5G Core Network (5GCN) 140. A 5G network may also be referred to as an NR network; NG-RAN 135 may be referred to as a 5G RAN or as an NR RAN; and 5GCN 140 may be referred to as an NG Core network. Standardization of an NG-RAN and 5GCN is ongoing in 3GPP. Accordingly, NG-RAN 135 and 5GCN 140 may conform to current or future standards for 5G support from 3GPP. The communication system 100 may further utilize information from space vehicles (SVs) 190 for a Global Navigation Satellite System (GNSS) like GPS, GLONASS, Galileo or Beidou or some other local or regional Satellite Positioning System (SPS) such as IRNSS, European Geostationary Navigation Overlay Service (EGNOS) or Wide Area Augmentation System (WAAS). Additional components of the communication system 100 are described below. The communication system 100 may include additional or alternative components.

It should be noted that FIG. 1 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the communication system 100. Similarly, the communication system 100 may include a larger (or smaller) number of SVs 190, gNBs 110, ng-eNBs 114, WLANs 116, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a SUPL-Enabled Terminal (SET), or by some other names. Moreover, UE 105 may correspond to a cellphone, smartphone, laptop, tablet, personal data assistant (PDA), tracking device, navigation device, Internet of Things (IoT) device, or some other portable or moveable device. Typically, though not necessarily, the UE 105 may support wireless communication using one or more RATs such as using GSM, Code Division Multiple Access (CDMA), Wideband CDMA (WCDMA), LTE, High Rate Packet Data (HRPD), IEEE 802.11 WiFi (also referred to as Wi-Fi), Bluetooth (BT), Worldwide Interoperability for Microwave Access (WiMAX), 5G New Radio (NR) (e.g., using the NG-RAN 135 and 5GCN 140), etc. The UE 105 may also support wireless communication using a WLAN which may connect to other networks (e.g. the Internet) using a Digital Subscriber Line (DSL) or packet cable for example. The use of one or more of these RATs may allow the UE 105 to communicate with an external client 130 (e.g. via elements of 5GCN 140 not shown in FIG. 1, or possibly via a Gateway Mobile Location Center (GMLC) 125) and/or allow the external client 130 to receive location information regarding the UE 105 (e.g., via the GMLC 125).

The UE 105 may include a single entity or may include multiple entities such as in a personal area network where a user may employ audio, video and/or data I/O devices and/or body sensors and a separate wireline or wireless modem. An estimate of a location of the UE 105 may be referred to as a location, location estimate, location fix, fix, position, position estimate or position fix, and may be geodetic, thus providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.) A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g. for latitude, longitude and altitude above or below mean sea level).

Base stations (BSs) in the NG-RAN 135 shown in FIG. 1 comprise gNBs, 110-1 and 110-2 (collectively and generically referred to herein as gNBs 110). Pairs of gNBs 110 in NG-RAN 135 may be connected to one another—e.g. directly as shown in FIG. 1 or indirectly via other gNBs 110. Access to the 5G network is provided to UE 105 via wireless communication between the UE 105 and one or more of the gNBs 110, which may provide wireless communications access to the 5GCN 140 on behalf of the UE 105 using 5G NR. 5G NR radio access may also be referred to as NR radio access or as 5G radio access. In FIG. 1, the serving gNB for UE 105 is assumed to be gNB 110-1, although other gNBs (e.g. gNB 110-2) may act as a serving gNB if UE 105 moves to another location or may act as a secondary gNB to provide additional throughout and bandwidth to UE 105.

Base stations (BSs) in the NG-RAN 135 shown in FIG. 1 may also or instead include a next generation evolved Node B, also referred to as an ng-eNB, 114. Ng-eNB 114 may be connected to one or more gNBs 110 in NG-RAN 135—e.g. directly or indirectly via other gNBs 110 and/or other ng-eNBs. An ng-eNB 114 may provide LTE wireless access and/or evolved LTE (eLTE) wireless access to UE 105. Some gNBs 110 (e.g. gNB 110-2) and/or ng-eNB 114 in FIG. 1 may be configured to function as positioning-only beacons which may transmit signals (e.g. PRS signals) and/or may broadcast assistance data to assist positioning of UE 105 but may not receive signals from UE 105 or from other UEs. It is noted that while only one ng-eNB 114 is shown in FIG. 1, some embodiments may include multiple ng-eNBs 114.

Communication system 100 may also include one or more WLANs 116 which may connect to a Non-3GPP InterWorking Function (N3IWF) 150 in the 5GCN 140 (e.g. in the case of an untrusted WLAN 116). For example, the WLAN 116 may support IEEE 802.11 WiFi access for UE 105 and may comprise one or more WiFi access points (APs). Here, the N3IWF 150 may connect to other elements in the 5GCN 140 such as AMF 115. In some embodiments, WLAN 116 may support another RAT such as Bluetooth. The N3IWF 150 may provide support for secure access by UE 105 to other elements in 5GCN 140 and/or may support interworking of one or more protocols used by WLAN 116 and UE 105 to one or more protocols used by other elements of 5GCN 140 such as AMF 115. For example, N3IWF 150 may support IPsec tunnel establishment with UE 105, termination of IKEv2/IPsec protocols with UE 105, termination of N2 and N3 interfaces to 5GCN 140 for control plane and user plane, respectively, relaying of uplink and downlink control plane Non-Access Stratum (NAS) signaling between UE 105 and AMF 115 across an N1 interface. In some other embodiments, WLAN 116 may connect directly to elements in 5GCN 140 (e.g. AMF 115 as shown by the dashed line in FIG. 1) and not via N3IWF 150—e.g. if WLAN 116 is a trusted WLAN for 5GCN 140. It is noted that while only one WLAN 116 is shown in FIG. 1, some embodiments may include multiple WLANs 116.

As referred to herein, access nodes may comprise any of a variety of network entities enabling communication between the UE 105 and the AMF 115. This can include gNBs 110, ng-eNB 114, WLAN 116 and/or other types of cellular base stations. However, access nodes providing the functionality described herein may additionally or alternatively include entities enabling communications to any of a variety of RATs not illustrated in FIG. 1, which may include non-cellular technologies. Thus, the term “access node,” as used in the embodiments described herein below, may include but is not necessarily limited to a gNB 110, ng-eNB 114 or WLAN 116.

As will be discussed in greater detail below, in some embodiments, an access node, such as a gNB 110, ng-eNB 114 or WLAN 116 (alone or in combination with other modules/units of the communication system 100), may be configured to, in response to receiving a request for location information for multiple RATs from the LMF 120, take measurements for one of the multiple RATs (e.g., measurements of the UE 105) and/or obtain measurements from the UE 105 that are transferred to the access node using one or more of the multiple RATs. As noted, while FIG. 1 depicts access nodes 110, 114 and 116 configured to communicate according to 5G NR, LTE and WiFi communication protocols, respectively, access nodes configured to communicate according to other communication protocols may be used, such as, for example, a Node B using a WCDMA protocol for a UMTS Terrestrial Radio Access Network (UTRAN), an eNB using an LTE protocol for an Evolved UTRAN (E-UTRAN), or a BT beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus EPC, where the E-UTRAN corresponds to NG-RAN 135 and the EPC corresponds to 5GCN 140 in FIG. 1. The methods and techniques described herein for UE 105 positioning using common or generic positioning procedures may be applicable to such other networks.

The gNBs 110 and ng-eNB 114 can communicate with an AMF 115, which, for positioning functionality, communicates with an LMF 120. The AMF 115 may support mobility of the UE 105, including cell change and handover of UE 105 from an access node 110, 114 or 116 of a first RAT to an access node 110, 114 or 116 of a second RAT. The AMF 115 may also participate in supporting a signaling connection to the UE 105 and possibly data and voice bearers for the UE 105. The LMF 120 may support positioning of the UE 105 when UE 105 accesses the NG-RAN 135 or WLAN 116 and may support position procedures and methods, including UE assisted/UE based and/or network based procedures/methods, such as Assisted GNSS (A-GNSS), OTDOA, Real Time Kinematics (RTK), Precise Point Positioning (PPP), Differential GNSS (DGNSS), ECID, OTDOA, angle of arrival (AOA), angle of departure (AOD), WLAN positioning, and/or other positioning procedures and methods. The LMF 120 may also process location services requests for the UE 105, e.g., received from the AMF 115 or from the GMLC 125. The LMF 120 may be connected to AMF 115 and/or to GMLC 125. The LMF 120 may be referred to by other names such as a Location Manager (LM), Location Function (LF), commercial LMF (CLMF) or value added LMF (VLMF). In some embodiments, a node/system that implements the LMF 120 may additionally or alternatively implement other types of location-support modules, such as an E-SMLC or SLP. It is noted that in some embodiments, at least part of the positioning functionality (including determination of a UE 105's location) may be performed at the UE 105 (e.g., using signal measurements obtained by UE 105 for signals transmitted by wireless nodes such as gNBs 110, ng-eNB 114 and/or WLAN 116, and/or using assistance data provided to the UE 105, e.g. by LMF 120).

The Gateway Mobile Location Center (GMLC) 125 may support a location request for the UE 105 received from an external client 130 and may forward such a location request to the AMF 115 for forwarding by the AMF 115 to the LMF 120 or may forward the location request directly to the LMF 120. A location response from the LMF 120 (e.g. containing a location estimate for the UE 105) may be similarly returned to the GMLC 125 either directly or via the AMF 115, and the GMLC 125 may then return the location response (e.g., containing the location estimate) to the external client 130. The GMLC 125 is shown connected to both the AMF 115 and LMF 120 in FIG. 1 though only one of these connections may be supported by 5GCN 140 in some implementations.

As further illustrated in FIG. 1, the LMF 120 may communicate with the gNBs 110 and/or with the ng-eNB 114 using the NRPPa protocol (which also may be referred to as NPPa). NRPPa may be the same as, similar to, or an extension of the LTE Positioning Protocol A (LPPa) protocol, with NRPPa messages being transferred between a gNB 110 and the LMF 120, and/or between an ng-eNB 114 and the LMF 120, via the AMF 115. As further illustrated in FIG. 1, LMF 120 and UE 105 may communicate using the LPP protocol. LMF 120 and UE 105 may also or instead communicate using an NPP protocol, which may be the same as, similar to, or an extension of LPP. Here, LPP and/or NPP messages may be transferred between the UE 105 and the LMF 120 via the AMF 115 and a serving gNB 110-1 or serving ng-eNB 114 for UE 105. For example, LPP and/or NPP messages may be transferred between the LMF 120 and the AMF 115 using messages for service based operations (e.g. based on the Hypertext Transfer Protocol (HTTP)) and may be transferred between the AMF 115 and the UE 105 using a 5G NAS protocol. The LPP and/or NPP protocol may be used to support positioning of UE 105 using UE assisted and/or UE based position methods such as A-GNSS, RTK, OTDOA and/or ECID. The NRPPa protocol may be used to support positioning of UE 105 using network based position methods such as ECID (e.g. when used with measurements obtained by a gNB 110 or ng-eNB 114) and/or may be used by LMF 120 to obtain location related information from gNBs 110 and/or ng-eNB 114, such as parameters defining PRS transmission from gNBs 110 and/or ng-eNB 114.

In the case of UE 105 access to WLAN 116, LMF 120 may use NRPPa and/or LPP/NPP to obtain a location of UE 105 in a similar manner to that just described for UE 105 access to a gNB 110 or ng-eNB 114. Thus, NRPPa messages may be transferred between a WLAN 116 and the LMF 120, via the AMF 115 and N3IWF 150 to support network based positioning of UE 105 and/or transfer of other location information from WLAN 116 to LMF 120. Alternatively, NRPPa messages may be transferred between N3IWF 150 and the LMF 120, via the AMF 115, to support network based positioning of UE 105 based on location related information and/or location measurements known to or accessible to N3IWF 150 and transferred from N3IWF 150 to LMF 120 using NRPPa. Similarly, LPP and/or NPP messages may be transferred between the UE 105 and the LMF 120 via the AMF 115, N3IWF 150 and serving WLAN 116 for UE 105 to support UE assisted or UE based positioning of UE 105 by LMF 120.

With a UE assisted position method, UE 105 may obtain location measurements and send the measurements to a location server (e.g. LMF 120) for computation of a location estimate for UE 105. For example, the location measurements may include one or more of a Received Signal Strength Indication (RSSI), Round Trip signal propagation Time (RTT), Reference Signal Time Difference (RSTD), Time of Arrival (TOA), Reference Signal Received Power (RSRP), Reference Signal Received Quality (RSRQ), Receive-Transmit time difference (Rx-Tx), Angle of Arrival (AOA), Angle of Departure (AOD) or Timing Advance (TA) for gNBs 110, ng-eNB 114 and/or one or more access points for WLAN 116. The location measurements may also or instead include measurements of GNSS pseudo-range, GNSS code phase and/or GNSS carrier phase for SVs 190. With a UE based position method, UE 105 may obtain location measurements (e.g. which may be the same as or similar to location measurements for a UE assisted position method) and may further compute a location of UE 105 (e.g. with the help of assistance data received from a location server such as LMF 120 or broadcast by gNBs 110, ng-eNB 114 or WLAN 116). With a network based position method, one or more base stations (e.g. gNBs 110 and/or ng-eNB 114), one or more APs (e.g. in WLAN 116) or N3IWF 150 may obtain location measurements (e.g. measurements of RSSI, RTT, RSRP, RSRQ, AOA or TOA) for signals transmitted by UE 105, and/or may receive measurements obtained by UE 105 or by an AP in WLAN 116 in the case of N3IWF 150, and may send the measurements to a location server (e.g. LMF 120) for computation of a location estimate for UE 105.

Information provided by the gNBs 110 and/or ng-eNB 114 to the LMF 120 using NRPPa may include timing and configuration information for PRS transmission and location coordinates. The LMF 120 can then provide some or all of this information to the UE 105 as assistance data in an LPP and/or NPP message via the NG-RAN 135 and the 5GCN 140.

An LPP or NPP message sent from the LMF 120 to the UE 105 may instruct the UE 105 to do any of a variety of things, depending on desired functionality. For example, the LPP or NPP message could contain an instruction for the UE 105 to obtain measurements for GNSS (or A-GNSS), WLAN, OTDOA and/or ECID (or some other position method). In the case of OTDOA, the LPP or NPP message may instruct the UE 105 to obtain one or more measurements (e.g. RSTD measurements) of PRS signals transmitted within particular cells supported by particular gNBs 110 and/or ng-eNB 114 (or supported by some other type of base station such as an eNB or WiFi AP). An RSTD measurement may comprise the difference in the times of arrival at the UE 105 of a signal (e.g. a PRS signal) transmitted or broadcast by one gNB 110 and a similar signal transmitted by another gNB 110. The UE 105 may send the measurements back to the LMF 120 in an LPP or NPP message (e.g. inside a 5G NAS message) via the serving gNB 110-1 (or serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GCN 140 may be configured to control different air interfaces. For example, in some embodiments, both the NG-RAN 135 and the 5GCN 140 may be replaced by other RANs and other core networks. For example, in an EPS, the NG-RAN 135 may be replaced by an E-UTRAN containing eNBs and the 5GCN 140 may be replaced by an EPC containing a Mobility Management Entity (MME) in place of the AMF 115, an E-SMLC in place of the LMF 120 and a GMLC that may be similar to the GMLC 125. In such an EPS, the E-SMLC may use LPPa in place of NRPPa to send and receive location information to and from the eNBs in the E-UTRAN and may use LPP to support positioning of UE 105. In these other embodiments, generic positioning procedures and methods for a UE 105 could be supported in an analogous manner to that described herein for a 5G network with the difference that functions and procedures described herein for gNBs 110, ng-eNB 114, AMF 115 and LMF 120 could, in some cases, apply instead to other network elements such eNBs, WiFi APs, an MME and an E-SMLC.

To support certain position methods such as OTDOA and transmission or PRS or other signals used in positioning of a UE 105, base stations may be synchronized. In a synchronized network, the transmission timing of gNBs 110 may be synchronized such that each gNB 110 has the same transmission timing as every other gNB 110 to a high level of precision—e.g. 50 nanoseconds or less. Alternatively, the gNBs 110 may be synchronized at a radio frame or subframe level such that each gNB 110 transmits a radio frame or subframe during the same time duration as every other gNB 110 (e.g. such that each gNB 110 starts and finishes transmitting a radio frame or subframe at almost precisely the same times as every other gNB 110), but does not necessarily maintain the same counters or numbering for radio frames or subframes. For example, when one gNB 110 is transmitting a subframe or radio frame with counter or number zero (which may be the first radio frame or subframe in some periodically repeated sequence of radio frames or subframes), another gNB 110 may be transmitting a radio frame or subframe with a different number or counter such as one, ten, one hundred etc.

Synchronization of the transmission timing of ng-eNBs 114 in NG-RAN 135 may be supported in a similar manner to synchronization of gNBs 110, although since ng-eNBs 114 may typically use a different frequency to gNBs 110 (to avoid interference), an ng-eNB 114 may not always be synchronized to gNBs 110. Synchronization of gNBs 110 and ng-eNBs 114 may be achieved using a GPS receiver or a GNSS receiver in each gNB 110 and ng-eNB 114 or by other means such as using the IEEE 1588 Precision Time Protocol.

As illustrated in FIG. 1, in certain aspects, a second UE 104 may be configured to perform a sidelink communication (e.g., using a carrier 192, such as a sidelink carrier) with UE 105 for a device-to-device (D2D) communication. In some aspects, the D2D communication may include a vehicle-to-everything (V2X) communication, such as a vehicle-to-vehicle (V2V) communication. The second UE 104 may communicate with UE 105 via the carrier 192 using one or more sidelink communication structures having at least one feedback symbol. In an aspect, at least a portion of a plurality of frequency bands for the carrier 192 corresponds to an Intelligent Transport System frequency spectrum for a sidelink carrier. In some aspects, the D2D communication may include D2D feedback (e.g., D2D sidelink feedback) communication as described herein.

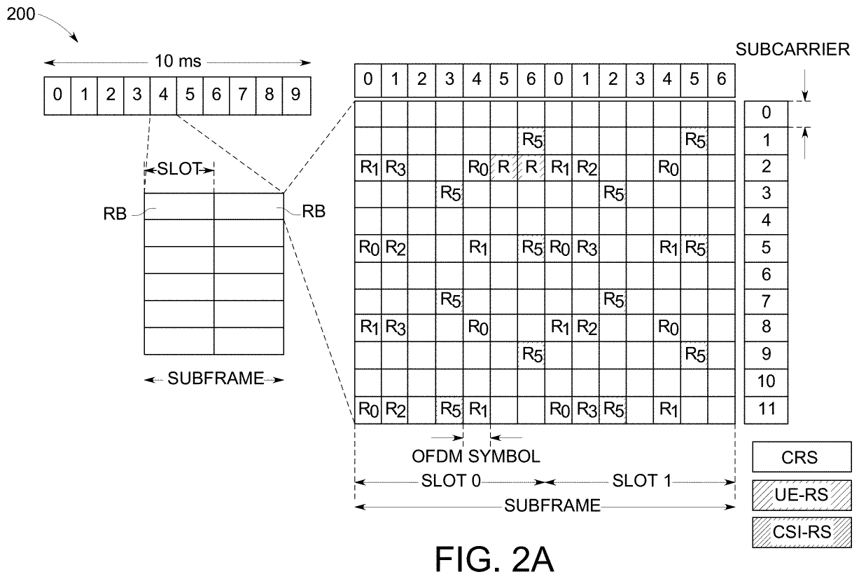

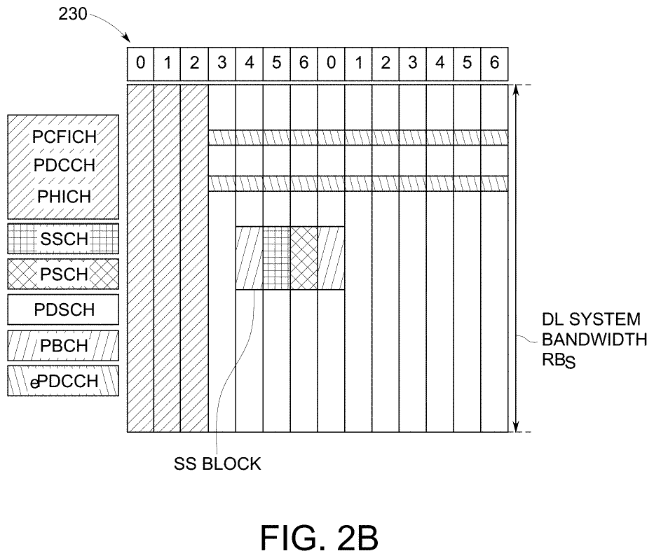

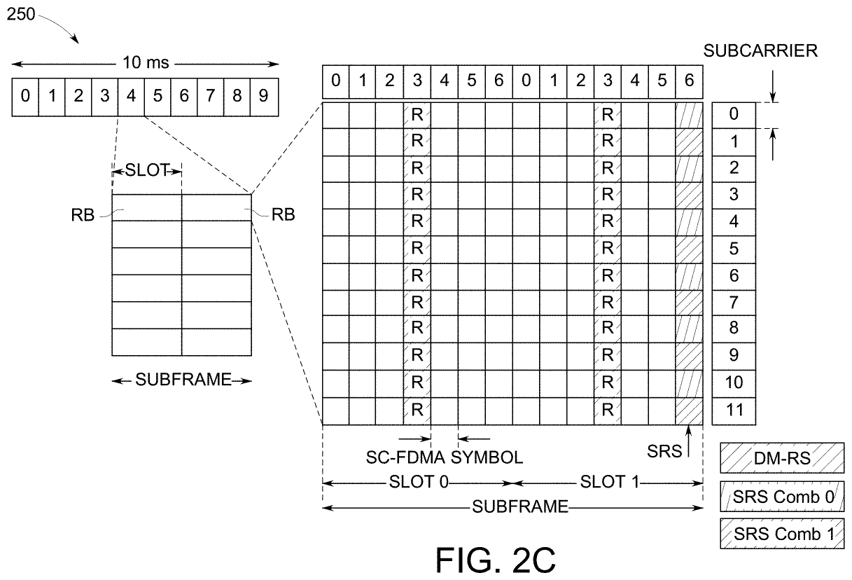

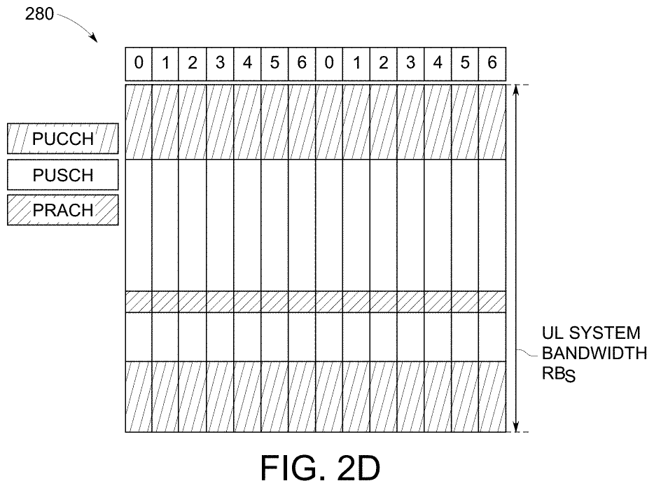

FIG. 2A is a diagram 200 illustrating an example of a frame structure of one or more downlink (DL) frames in accordance with various aspects of the present disclosure. FIG. 2B is a diagram 230 illustrating an example of channels within the frame structure of a DL frame in accordance with various aspects of the present disclosure. FIG. 2C is a diagram 250 illustrating an example of a frame structure of one or more uplink (UL) frames in accordance with various aspects of the present disclosure. FIG. 2D is a diagram 280 illustrating an example of channels within the frame structure of a UL frame in accordance with various aspects of the present disclosure. Other wireless communication technologies may have a different frame structure and/or different channels. A frame (e.g., a 10-ms frame) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers (e.g., for 15 kHz subcarrier spacing) in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (e.g., also sometimes called common R5), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

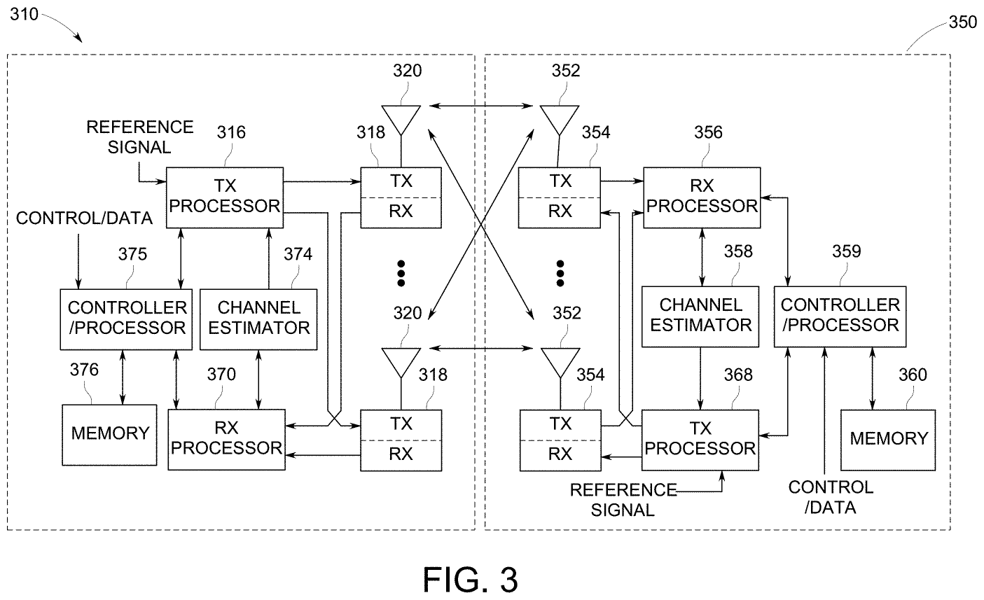

FIG. 3 is a block diagram of a base station 310 in communication with a UE 350 in an access network. In the DL, IP packets from, for example, an Evolved Packet Core (EPC), may be provided to a controller/processor 375. The controller/processor 375 may implement layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 may provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), de-multiplexing of MAC SDUs from TBs, scheduling information reporting, error correction through HARQ, priority handling, and logical channel prioritization.

The transmit (TX) processor 316 and the receiver (RX) processor 370 may implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter (TX) of transceiver 318. Each transmitter (TX) of transceiver 318 may modulate an RF carrier with a respective spatial stream for transmission.

At the UE 350, the receiver of each transceiver 354 receives a signal through its respective antenna 352. The receiver of each transceiver 354 recovers information modulated onto an RF carrier and provides the information to the receiver (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and de-interleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides de-multiplexing between transport and logical channels, packet reassembly, deciphering, header decompression, and control signal processing to recover IP packets from the EPC. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, de-multiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters of transceivers 354 Each transmitter of a transceiver 354 may modulate an RF carrier with a respective spatial stream for transmission.

The UL transmission is processed at the base station 310 in a manner similar to that described in connection with the receiver function at the UE 350. The receiver of each transceiver 318 receives a signal through its respective antenna 320. The receiver of each transceiver 318 recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides de-multiplexing between transport and logical channels, packet reassembly, deciphering, header decompression, control signal processing to recover IP packets from the UE 350. IP packets from the controller/processor 375 may be provided to the EPC. The controller/processor 375 is also responsible for error detection using an ACK and/or NACK protocol to support HARQ operations.

In some aspects, UE 350 may include means for communicating a sidelink traffic communication using a sidelink communication structure, and means for communicating an allotting for sidelink feedback using at least one feedback symbol of the sidelink communication structure. In some aspects, UE 350 may include means for communicating a sidelink feedback communication using at least one feedback symbol of the sidelink communication structure, where the sidelink feedback communication is associated with the sidelink traffic communication. In some aspects, such means may include one or more components of UE 350 described in connection with FIG. 3.

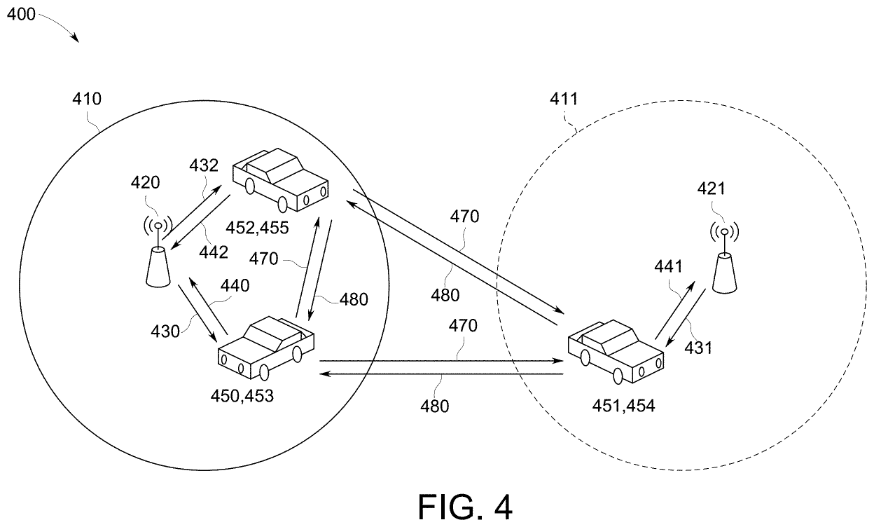

FIG. 4 is a diagram of a D2D communication system 400 which may include a V2X communication system and/or a V2V communication system. In the illustrated example, the D2D communication system 400 may include a first vehicle 453 that communicates with a second vehicle 454. In some aspects, the first vehicle 453 and/or the second vehicle 454 may be configured to communicate in a specific spectrum, such as an intelligent transport systems (ITS) spectrum. The ITS spectrum may be unlicensed, and therefore a plurality of different technologies may use the ITS spectrum for communication, including LTE, LTE-Advanced, Licensed Assisted Access (LAA), Dedicated Short Range Communications (DSRC), 5G, new radio (NR), 4G, and the like. The foregoing list of technologies is to be regarded as illustrative, and is not meant to be exhaustive.

The D2D communication system 400 may utilize LTE technology or another technology (e.g., 5G NR). For example, a vehicle in D2D communication may incorporate therein a UE of the LTE or 5G NR technology. In D2D communication (e.g., V2X communication or V2V communication), the first vehicle 453 and the second vehicle 454 may be in networks of different mobile network operators (MNOs). Each of the networks may operate in its own frequency spectrum. For example, the air interface to a first vehicle 453 may be in one or more frequency bands different from the air interface of the second vehicle 454. The first vehicle 453 and the second vehicle 454 may communicate via a sidelink (e.g., using a carrier 192, such as a sidelink carrier), for example, via a PC5 interface. In some examples, the MNOs may schedule sidelink communication between or among the vehicles 453 and 454 in V2X spectrum (e.g., V2V spectrum). An example of the V2X spectrum may include the intelligent transport system (ITS) frequency spectrum. In some aspects, a D2D communication (e.g., a sidelink communication) between or among vehicles 453 and 454 may not be scheduled by MNOs.

The D2D communication system 400 may be present where devices (e.g., vehicles) operate in networks of different MNOs and/or different frequency spectrums. For example, each of the vehicles in a D2D (e.g., V2V or V2X) communication system may have a subscription from a respective corresponding MNO. The V2X spectrum may be shared with the frequency spectrums of the MNOs. In some examples, the D2D (e.g., V2V or V2X) communication system 400 may be deployed where the first vehicle 453 operates in the network operated by a first MNO, and the second vehicle 454 is not in a network—e.g., the V2X spectrum may have no network deployed.

The first vehicle 453 may be in D2D (e.g., V2V or V2X) communication with the second vehicle 454. In the illustrated example, the first vehicle 453 incorporates a first UE 450, and the second vehicle 454 incorporates a second UE 451. The first UE 450 may operate on a first network 410 (e.g., of the first MNO). In some aspects, the D2D communication system 400 may further include a third vehicle 455 that incorporates a third UE 452. The third UE 452 may operate on, for example, the first network 410 (e.g., of the first MNO) or another network. The third vehicle 455 may be in D2D (e.g., V2V or V2X) communication with the first vehicle 453 and/or second vehicle 454.

The first network 410 operates in a first frequency spectrum and includes the first base station 420 communicating at least with the first UE 450, for example, as described in FIGS. 1-3. The first base station 420 may communicate with the first UE 450 via a DL carrier 430 and/or an UL carrier 440. The DL communication may be performed via the DL carrier 430 using various DL resources (e.g., the DL subframes (FIG. 2A) and/or the DL channels (FIG. 2B)). The UL communication may be performed via the UL carrier 440 using various UL resources (e.g., the UL subframes (FIG. 2C) and the UL channels (FIG. 2D)).

In some aspects, the second UE 451 may not be on a network. In some aspects, the second UE 451 may be on a second network 411 (e.g., of the second MNO). The second network 411 may operate in a second frequency spectrum (e.g., a second frequency spectrum different from the first frequency spectrum) and may include the second base station 421 communicating with the second UE 451, for example, as described in FIGS. 1-3.

The second base station 421 may communicate with the second UE 451 via a DL carrier 431 and an UL carrier 441. The DL communication is performed via the DL carrier 431 using various DL resources (e.g., the DL subframes (FIG. 2A) and/or the DL channels (FIG. 2B)). The UL communication is performed via the UL carrier 441 using various UL resources (e.g., the UL subframes (FIG. 2C) and/or the UL channels (FIG. 2D)).

The D2D (e.g., V2V or V2X) communication may be carried out via one or more sidelink carriers 470 and 480. The one or more sidelink carriers 470 and 480 may include one or more channels, such as a physical sidelink broadcast channel (PSBCH), a physical sidelink discovery channel (PSDCH), a physical sidelink shared channel (PSSCH), and a physical sidelink control channel (PSCCH).

In some examples, the sidelink carriers 470, 480 may operate using the PC5 interface. The first UE 450 (e.g., incorporated in the first vehicle 453) may transmit to one or more (e.g., multiple) devices, including to the second UE 451 (e.g., incorporated in the second vehicle 454) via the first sidelink carrier 470. The second UE 451 may transmit to one or more (e.g., multiple) devices, including to the first UE 450 (e.g., incorporated in the vehicle 453) via the second sidelink carrier 480.

In some aspects, the UL carrier 440 and the first sidelink carrier 470 may be aggregated to increase bandwidth. In some aspects, the first sidelink carrier 470 and/or the second sidelink carrier 480 may share the first frequency spectrum (with the first network 410) and/or share the second frequency spectrum (with the second network 411). In some aspects, the sidelink carriers 470 and 480 may operate in an unlicensed spectrum.

The examples of methods and apparatuses discussed infra are applicable to any of a variety of wireless D2D (e.g., V2V or V2X) communication systems. To simplify the discussion, the examples of methods and apparatus may be discussed within the context of LTE. However, one of ordinary skill in the art would understand that the methods and apparatuses are applicable more generally to a variety of other wireless D2D (e.g., V2V or V2X) communication systems, including 5G.

In certain aspects, a sidelink communication on a sidelink carrier may occur between the first UE 450 (e.g., incorporated in the first vehicle 453) and the second UE 451 (e.g., incorporated in the second vehicle 454). In an aspect, the first UE 450 (e.g., incorporated in the first vehicle 453) may perform a sidelink communication with one or more (e.g., multiple) devices, including to the second UE 451 (e.g., incorporated in the second vehicle 454) via the first sidelink carrier 470. For example, the first UE 450 may transmit a broadcast transmission via the first sidelink carrier 470 to the multiple devices (e.g., the second and third UEs 451 and 452). The second UE 451 (e.g., among other UEs) may receive such broadcast transmission. Additionally or alternatively, the first UE 450 may transmit a multicast transmission via the first sidelink carrier 470 to the multiple devices. The second UE 451 (e.g., among other UEs) may receive such multicast transmission. Further, additionally or alternatively, the first UE 450 may transmit a unicast transmission via the first sidelink carrier 470 to a device, such as the second UE 451. The second UE 451 (e.g., among other UEs) may receive such unicast transmission. Additionally or alternatively, in an aspect, the second UE 451 (e.g., incorporated in the second vehicle 454) may perform a sidelink communication with one or more (e.g., multiple) devices, including the first UE 450 (e.g., incorporated in the first vehicle 453) via the second sidelink carrier 480. For example, the second UE 451 may transmit a broadcast transmission via the second sidelink carrier 480 to the multiple devices. The first UE 450 (e.g., among other UEs) may receive such broadcast transmission. Additionally or alternatively, the second UE 451 may transmit a multicast transmission via the second sidelink carrier 480 to the multiple devices (e.g., the first and third UEs 450 and 452). The first UE 450 (e.g., among other UEs) may receive such multicast transmission. Further, additionally or alternatively, the second UE 451 may transmit a unicast transmission via the second sidelink carrier 480 to a device, such as the first UE 450. The first UE 450 (e.g., among other UEs) may receive such unicast transmission. The third UE 452 may communicate in a similar manner.

In certain aspects, for example, such a sidelink communication on a sidelink carrier between the first UE 450 and the second UE 451 may occur without having MNOs allocating resources (e.g., one or more portions of a resource block (RB), slot, frequency band and/or channel associated with a sidelink carrier 470, 480) for such communication and/or without scheduling such communication. In certain aspects, a sidelink communication may include a traffic communication (e.g., a data communication, control communication, a paging communication and/or a system information communication). Further, in certain aspects, a sidelink communication may include a sidelink feedback communication associated with a traffic communication (e.g., a transmission of feedback information for a previously-received traffic communication). In certain aspects, a sidelink communication may employ at least one sidelink communication structure having at least one feedback symbol. The feedback symbol of the sidelink communication structure may allot for any sidelink feedback information that may be communicated in the device-to-device (D2D) communication system 400 between devices (e.g., a first vehicle 453 and a second vehicle 454).

In some aspects, a sidelink traffic communication and/or a sidelink feedback communication may be associated with one or more transmission time intervals (TTIs). In some aspects, a TTI may be 0.5 ms, although a larger or smaller value may be employed. In some aspects, a TTI may be associated with and/or correspond to a communication structure slot. However, a TTI may be associated with a larger or smaller and/or different communication structure dimension and/or time unit (e.g., one or more slots, subframes, or frames). In certain aspects of the present methods and apparatus, a sidelink communication (e.g., sidelink traffic communication and/or a sidelink feedback communication) in the D2D communication system 400 may include at least one sidelink communication structure having a sidelink feedback symbol (e.g., to allot for communication of feedback information). For example, during a first TTI, a device in the D2D communication system 400 (e.g., the first vehicle 453) transmitting a sidelink traffic communication using the sidelink communication structure having a sidelink feedback symbol may refrain from transmitting traffic information in one or more portions of the sidelink feedback symbol. In some aspects, the sidelink traffic communication may be transmitted by the first vehicle 453 to one or more of any remaining devices (e.g., to the second vehicle 454) in the D2D communication system 400. Furthermore, during the first TTI another device in the D2D communication system 400 (e.g., the second vehicle 454) that is transmitting a sidelink feedback communication using the wireless communication structure having a sidelink feedback symbol may transmit feedback information in one or more portions of the sidelink feedback symbol. In this manner, sidelink communication (e.g., including a sidelink traffic communication and a sidelink feedback communication) may occur efficiently, without having MNOs allocate resources for such communication, and/or without having MNOs schedule such communication.

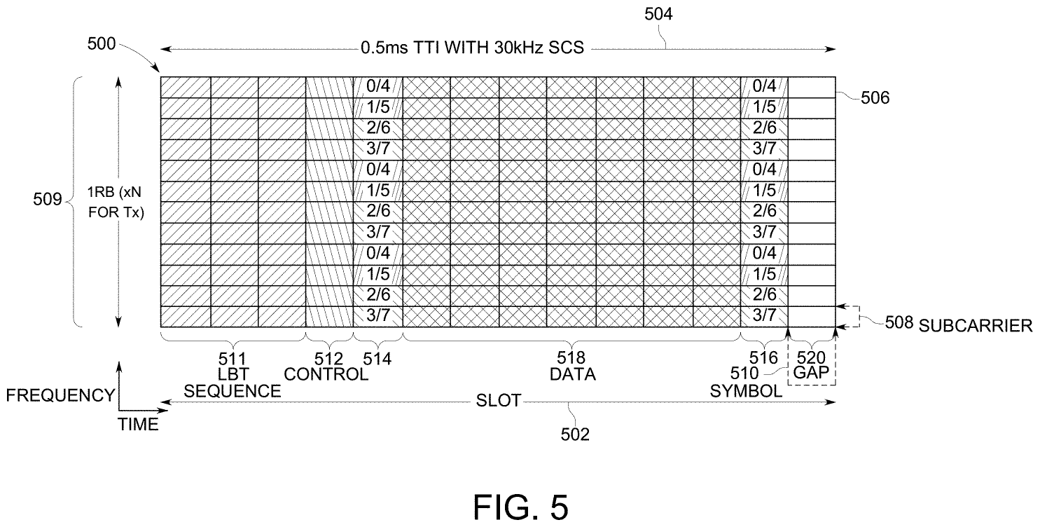

FIG. 5 is a diagram illustrating an example of a sidelink communication structure 500 in accordance with various aspects of the present disclosure. The sidelink communication structure 500 may be defined by resources in a frequency domain and time domain. For example, the sidelink communication structure 500 may represent a time slot 502 and/or correspond to a TTI 504 (e.g., 0.5 ms). A resource grid may be used to represent the time slot 502 including one or more time concurrent resource blocks (RBs) (also referred to as physical RBs (PRBs)). The resource grid is divided into multiple resource elements (REs). In aspects, a RB 506 includes 12 consecutive subcarriers (e.g., having 30 kHz subcarrier spacing) 508 in the frequency domain and 14 consecutive symbols 510 in the time domain, for a total of 168 REs. In aspects, a RB contains 12 consecutive subcarriers in the frequency domain and 12 consecutive symbols in the time domain, for a total of 144 REs. In aspects, a device (e.g., the first vehicle 453) may employ a plurality of resources blocks (e.g., N RBs) for a sidelink communication 509 (e.g., a sidelink transmission) in the D2D communication system 400. The sidelink communication 509 may correspond to a single TTI.

In aspects, one or more symbols 510 (e.g., one or more of the first three symbols 511) of the sidelink communication structure 500 may be employed to communicate a listen-before-talk (LBT) sequence in a sidelink communication. Transmission of the sidelink communication by a device may be based on the LBT sequence. In aspects, one or more symbols (e.g., the fourth symbol 512) of the sidelink communication structure 500 may be employed to communicate control information in a sidelink communication. In aspects, one or more symbols 510 (e.g., the fifth 514 and thirteenth symbols 516) of the sidelink communication structure 500 may be employed to communicate reference signals (e.g., demodulation reference signals (DM-RSs) associated with ports 0-7) in a sidelink communication as shown. In aspects, one or more symbols 510 (e.g., the sixth through twelfth symbols 518) of the sidelink communication structure 500 may be employed to communicate data in a sidelink communication. In aspects, one or more symbols 510 (e.g., the fourteenth symbol 520) of the sidelink communication structure 500 may be configured as a guard period to accommodate uplink-downlink switching (e.g., turnaround) time.

In aspects, for example, the sidelink communication structure 500 may be employed for a broadcast sidelink communication. For example, the sidelink communication structure 500 may be employed for a broadcast sidelink transmission from a device (e.g., the first vehicle 453) in the D2D communication system 400 to a plurality of other devices (e.g., including the second vehicle 454) device in the D2D communication system 400. The sidelink communication structure 500 described above is exemplary and may be defined differently in the time and/or frequency domain. Additionally or alternatively, the sidelink communication structure 500 may be differently associated with a TTI (e.g., correspond to one or more portions of a TTI).

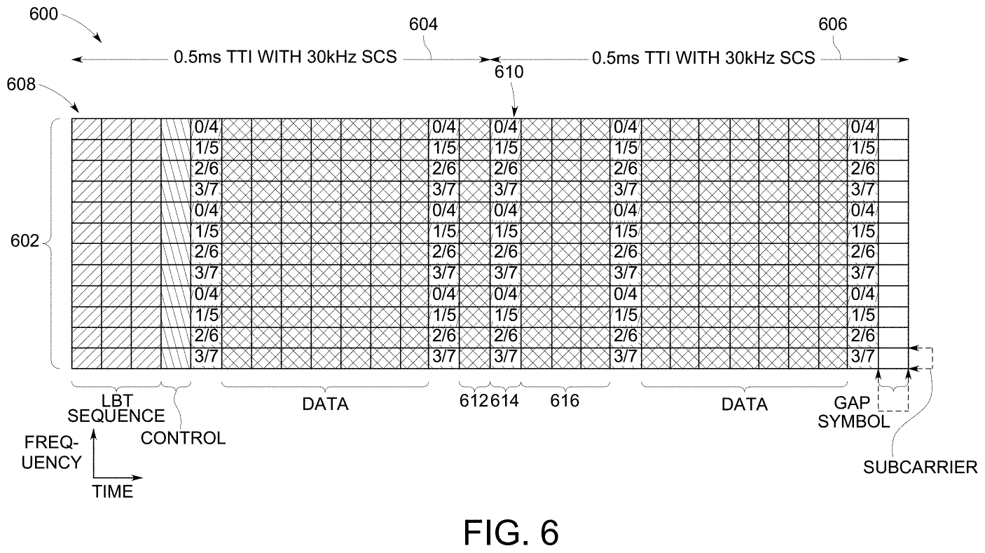

FIG. 6 is a diagram illustrating examples of sidelink communication structures 600 in accordance with various aspects of the present disclosure. In aspects, a sidelink communication 602 may be associated with and/or correspond to a plurality of TTIs. For example, in aspects, the sidelink communication 602 may employ TTI-bundling in which a data portion of a sidelink communication may span a plurality of TTIs (e.g., a first TTI 604 and a second TTI 606). In aspects, the sidelink communication 602 may employ a plurality of sidelink communication structures (e.g., a first and second sidelink communication structures 608 and 610). The first and second sidelink communication structures 608 and 610 may be similar to the sidelink communication structure 500. However, the first and/or second sidelink communication structures 608 and 610 may be adapted for TTI-bundling. In aspects, one or more portions of overhead (e.g., a LBT portion, control portion and/or guard period portion) associated with a sidelink communication structure may not be employed for every sidelink communication structure associated with a sidelink communication employing TTI-bundling. For example, rather than being employed as a guard period for uplink-downlink switching time, the last symbol 612 of the first sidelink communication structure 608 may be employed for data. Similarly, rather than being employed for LBT sequence(s) and/or control information, the first four symbols of the second sidelink communication structure 610 may be employed for reference signals and/or data. For example, a first symbol 614 of the second sidelink communication structure 610 may be employed for reference signals (e.g., DM-RS signals) and the next three symbols 616 may be employed for data.

In aspects of the present methods and apparatus, a sidelink communication (e.g., sidelink traffic communication and/or a sidelink feedback communication) in the D2D communication system 400 may include at least one wireless communication structure having a sidelink feedback symbol (e.g., to allot for communication of sidelink feedback information). In this manner, sidelink communication (e.g., including a sidelink traffic communication and a sidelink feedback communication) may occur efficiently, without having MNOs allocate resources for such communication, and/or without having MNOs schedule such communication.

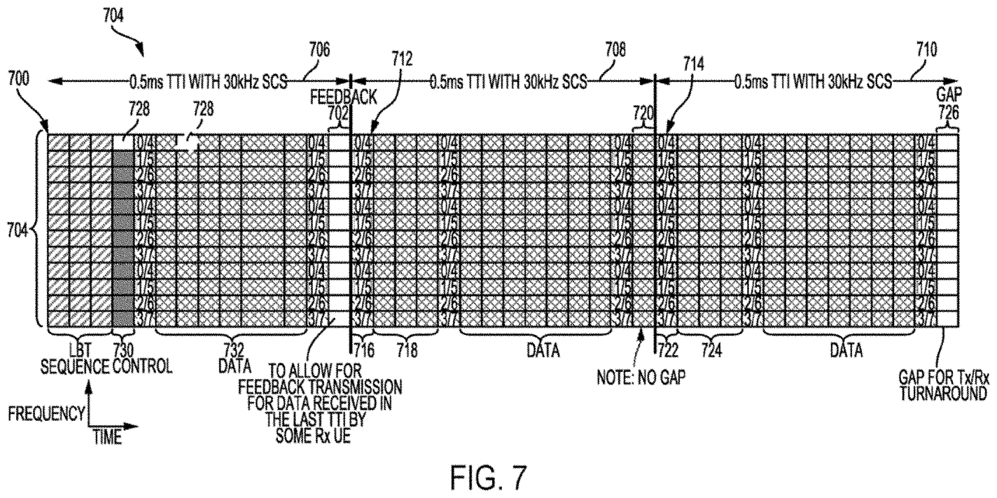

FIG. 7 is a diagram illustrating a sidelink communication structure 700 having at least one feedback symbol 702 in accordance with various aspects of the present disclosure. For example, a sidelink communication 704 may be associated with and/or correspond to a plurality of TTIs. In aspects, the sidelink communication 704 may employ TTI-bundling, for example, in which a data portion of a sidelink communication may span a plurality of TTIs (e.g., a first TTI 706, second TTI 708 and third TTI 710). In aspects, the sidelink communication 704 may employ a plurality of sidelink communication structures (e.g., a first sidelink communication structure 700, a second sidelink communication structure 712, and a third sidelink communication structure 714). In aspects, the first sidelink communication structure 700 may serve as a first communication structure, the second sidelink communication structure 712 may serve as an intermediate communication structure, and a third sidelink communication structure 714 may serve as the last communication structure of the TTI-bundled sidelink communication. The first sidelink communication structure 700 may be similar to the sidelink communication structure 500. However, in contrast to the sidelink communication structure 500, the sidelink communication structure 700 includes at least one feedback symbol 702 (e.g., a sidelink feedback symbol). In aspects, the at least one feedback symbol 702 may be a last symbol of the sidelink communication structure 700. However, in aspects, the at least one feedback symbol 702 may be a different symbol of the sidelink communication structure 700. In aspects, the at least one feedback symbol 702 may be a plurality of symbols in the sidelink communication structure 700. In aspects, intermediate and last communication structures, such as the second and third sidelink communication structures 712 and 714, respectively, may be similar to the sidelink communication structure 500. However, the second and/or third sidelink communication structures 712 and 714 may be adapted for TTI-bundling. In aspects, one or more portions of overhead (e.g., a LBT portion, control portion and/or guard period portion) associated with a sidelink communication structure may not be employed for every sidelink communication structure associated with a sidelink communication employing TTI-bundling. For example, a first symbol 716 of the second sidelink communication structure 712 may be employed for reference signals (e.g., DM-RS signals) and the next three symbols 718 may be employed for data. Further, the last symbol 720 of the second sidelink communication structure 712 may be employed for data. Similarly, a first symbol 722 of the third sidelink communication structure 714 may be employed for reference signals (e.g., DM-RS signals) and the next three symbols 724 may be employed for data. The last symbol 726 of the third sidelink communication structure 714 may be used as a guard period to accommodate uplink-downlink switching time.

By employing a sidelink communication structure having at least one feedback symbol, such as sidelink communication structure 700 for a sidelink communication by a device, a TTI structure is modified to facilitate a sidelink communication (e.g., a unicast, multicast, and/or broadcast sidelink transmission by the device) with feedback (e.g., with an allotting for feedback to be transmitted by another device during the TTI and/or with an allotting for a device receiving the transmission to transmit feedback using the feedback symbol in a subsequent TTI using the TTI structure). Thus, in aspects, the present methods and apparatus facilitate feedback for a received transmission in a non-self-contained manner. To wit, feedback regarding data is sent by a receiving device m-TTIs after the device receives the data, where m is an integer (e.g., 1, 2, 3, etc.).

Although the sidelink communication structure 700 having at least one feedback symbol 702 is described above in the context of TTI-bundling, the present methods and apparatus include any sidelink communication structure having at least one feedback symbol 702. For example, the present methods and apparatus include a wireless communication structure similar to one or more of sidelink communication structures 500, 608, 610, 712, 714 adapted to include the at least one feedback symbol 702 in lieu of one or more portion of existing symbol(s) described above.

The sidelink communication structure having at least one feedback symbol of the present methods and apparatus may be employed for device-to-device communication. In aspects, a device, such as for example, the first UE 450, transmitting a sidelink communication (e.g., a sidelink traffic communication) may employ rate matching and/or puncturing techniques to create the at least one feedback symbol 702. If the first UE 450 transmits a sidelink communication for N TTIs, a symbol (e.g., an identified symbol, such as a last symbol) of each of a subset of sidelink communication structures included in or corresponding to the N TTIs may be the at least one feedback symbol 702, where N is an integer (e.g., 1, 2, 3, etc.). For example, the identified symbol (e.g., last symbol) associated with a first subset of TTI(s), A, of the set of TTIs, {1, . . . , N} of a N-TTI transmission are used as a feedback symbol(s). In aspects, the first subset of A may include {1}, {1, N}, {1, . . . , N}, for example. However, a different subset may be employed. In aspects, the sidelink communication transmitted by the first UE 450 may include an indication 728 to one or more devices that receive the sidelink communication, such as for example, the second UE 451, of a subset B of the first subset A described above. The subset B may be used to determine a TTI and/or sidelink communication structure, associated with subset B, in which to send feedback. In aspects, for example, the indication 728 may be indicated by or included in a control portion 730 or may be included in a data portion 732 (e.g., in a medium access control (MAC) control element (CE) in the sidelink communication transmitted by the first UE 450. In this manner, one or more devices, such as the second UE 451 may determine when to transmit feedback information (e.g., associated with the received sidelink communication or another communication) in a subsequent TTI based on the received sidelink communication. In aspects, the first subset may be based on an RRC configuration or pre-configuration (e.g., a provisioned RRC configuration for the second UE 451).

In aspects, a device, such as a UE 450 or 451, may communicate a sidelink traffic communication by transmitting the sidelink traffic communication to one or more UEs. Such device may communicate a sidelink feedback communication in one or more portions of at least one feedback symbol by receiving the sidelink feedback communication. Additionally or alternatively, in aspects, a device, such as a UE 450 or 451, may communicate a sidelink traffic communication by receiving the sidelink traffic communication from one or more UEs. Such device may communicate a sidelink feedback communication in one or more portions of at least one feedback symbol by transmitting the sidelink feedback communication.

In aspects, for traffic (e.g., data) of a sidelink traffic communication received (e.g., from the second UE 451) in TTIn, the first UE 450 may transmit feedback information in the feedback symbol 702 associated with a subsequent TTI, TTIn+m occurring m TTIs after TTIn, where n and m are integers. In aspects, m=1. To wit, the first UE 450 may transmit the feedback information in the TTI succeeding (e.g., immediately succeeding) TTInn aspects, the value for m may be based on the subset B. In aspects, for example, the first UE 450 may determine or assume a similar pattern may be employed for sidelink communication in subsequent TTIs. Thus, the first UE 450 may determine a subsequent TTI in which to transmit the sidelink feedback communication based the subset B.

In aspects, frequency resources employed to transmit the sidelink feedback information in the feedback symbol 702 may be based on frequency resources employed for the sidelink traffic (e.g., data) communication. In aspects, for traffic of a sidelink traffic communication received by the first UE 450 (e.g., from the second UE 451) using a set of frequency resources (e.g., 120 subcarriers), the first UE 450 may transmit sidelink feedback information in the feedback symbol 702 using the set of frequency resources (e.g., all the frequency resources as used for the data transmission). In aspects, for traffic of a sidelink traffic communication received by the first UE 450 (e.g., from the second UE 451) using a set of frequency resources (e.g., 120 subcarriers), the first UE 450 may transmit sidelink feedback information in the feedback symbol 702 using a subset of the set of frequency resources. For example, in aspects, the first UE 450 may employ a subset of the set of frequency resources for the sidelink traffic transmission by employing at least the first subchannel of a plurality of subchannels used for the traffic transmission for the sidelink feedback transmission. In aspects, a subchannel and/or the plurality of subchannels may be, for example a frequency range based on a number of resource blocks used for the sidelink traffic communication. In aspects, the first UE 450 may employ a subset of the set of frequency resources for the sidelink traffic transmission by employing at least a first subchannel used for traffic (e.g., data) transmission. In aspects, the first UE 450 may employ a subset of the set of frequency resources for the sidelink traffic transmission by employing a subchannel for the sidelink feedback transmission based on measuring, by the first UE 450, of at least one of signal strength, power, or quality associated with communicating the sidelink traffic communication on the frequency resources of the sidelink traffic communication. For example, the subset may be based on or include at least a lowest energy subchannel based on past sensing on sidelink traffic communication resources.

In aspects, the first UE 450 may employ a first subcarrier spacing (e.g., 15 kHz) for a data traffic communication. To facilitate automatic gain control (AGC), the first UE 450 may transmit feedback information in the feedback symbol 702 using a subcarrier spacing associated with the sidelink feedback communication that is the subcarrier spacing associated with the sidelink traffic communication increased by a factor (e.g., twice the subcarrier spacing used for data transmissions). For example, a subcarrier spacing associated with the sidelink feedback communication may be an integer multiple of a subcarrier spacing associated with a data traffic communication. Such sidelink feedback communication may include repetitive communication of sidelink feedback information in one or more portions of at least two feedback symbols respectively (e.g., identical feedback symbol repeated two or more times) of the sidelink communication structure having at least one feedback symbol. In this manner, the second UE 451 may reduce and/or avoid the adverse effects associated with improper AGC (e.g., saturation and/or clipping) while receiving the sidelink feedback communication. For example, the second UE 451 may perform AGC based on the first of such two feedback symbols such that the second of such two feedback symbols may be successfully processed to determine feedback information.

In aspects, for a sidelink traffic communication received by the first UE 450 (e.g., from the second UE 451), the first UE 450 may scramble the feedback information bits before transmitting the feedback information in the feedback symbol 702. In aspects, the first UE 450 may employ an identifier (ID) associated with the first UE 450 to scramble the feedback information bits. In aspects, the ID may be assigned or configured. In this manner, if the sidelink traffic communication transmit by the second UE 451 is a multicast or broadcast transmission, the second UE 451 may determine the source (e.g., based on the ID) of a received sidelink feedback communication for the previously-transmitted sidelink traffic communication.

In aspects, for a sidelink traffic communication received by the first UE 450 (e.g., from the second UE 451), the first UE 450 may determine a power for a sidelink feedback communication (e.g., a sidelink feedback transmission) with the second UE 451 using a predetermined value or based on a measurement performed by the first UE 450 of one or more reference signals. For example, the first UE 450 may determine a transmit power for the sidelink feedback information based on a received data power (e.g., function of RSRP measurements performed on DMRSs) or based on fixing the transmit power for the feedback information to a value (e.g., a maximum value). The first UE 450 may use such determined power for a sidelink feedback communication.

In aspects, for a received sidelink traffic communication (e.g., from the second UE 451), the first UE 450 may transmit feedback information communication to the second UE 451 including at least one of positive/negative acknowledgement (ACK/NACK) information, channel quality indicator (CQI) information, rank indicator (RI) information, precoding matrix indicator (PMI) information, buffer status information (e.g., buffer status report), or timing information of a subsequent transmission by a source (e.g., the first UE 450) of the feedback information. In aspects, such sidelink feedback information (e.g., the timing information of a subsequent sidelink transmission) may facilitate sidelink communication coordination among devices (e.g., the first UE 450, the second UE 451 and the third UE 452) in the D2D communication system 400 since, in aspects, D2D communication (e.g., sidelink communication) between or among vehicles 453, 454, 455 is not scheduled by MNOs.

However, the sidelink communication structure 500 and sidelink communication structures 600 shown in FIGS. 5 and 6 may not allot for feedback communication. Thus, a device in the D2D communication system 400 (e.g., the first vehicle 453) using (e.g., solely) such structures 500 and 600 may be unable to communicate feedback information without adversely affecting transmission and/or reception of other types of communication (e.g., traffic communication).

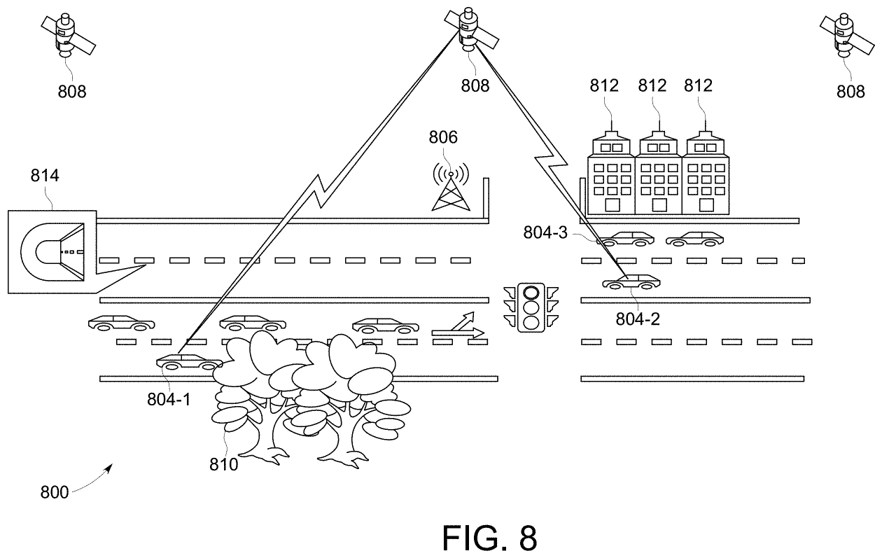

FIG. 8 is a diagram providing an overhead view of a divided road 800 with an exemplary traffic intersection 802, provided to help illustrate how V2X communication can be used by vehicles 804-1, 804-2, 804-3 (collectively and generically referred to herein as vehicles 804) to provide useful information that can be used by vehicles 804 to help ensure the safety of passengers therein. It will be understood that FIG. 8, as with other figures provided herein, is provided as a non-limiting example. As a person of ordinary skill in the art will appreciate, the number of scenarios in which V2X communication can be useful extend far beyond this example. Some scenarios can include more or fewer vehicles, different types of vehicles, as well as non-vehicle entities, such as RSUs, Vulnerable Road Users (VRUs), road hazards and other objects, and the like, which may or may not be capable of V2X communication.

In the illustrated divided road 800, an edge network device 806 is located on the side of the divided road 800. The edge network device 806 is capable of transmitting one or more messages to the vehicles 804. One or more satellites 808 can transmit a navigation signal (e.g., a Global Positioning System (GPS) timing signal). In various navigation systems, signals from multiple (e.g., four or more) satellites may be used to generate accurate geographic information. Upon receiving the navigation signals by receivers in the vehicle, the navigation systems can determine a location of the vehicle. For satellite-based navigation systems, a relatively unobstructed view of the sky is generally required. Obstructed views can inhibit the reception of the navigation signals and can interfere with the calculation of an accurate location.

In a first non-limiting example, dense foliage 810 can inhibit the reception of navigation signals by vehicle 804-1 as the vehicle enters an area covered by the foliage 810. After exiting the foliage 810, the navigation signals can be received again by the receiver in the vehicle 804-1.

In a second non-limiting example, a vehicle 804-2 can enter into a tunnel 814. As the vehicle 804-2 enters the tunnel 814, the navigation signals can be obstructed by the walls of the tunnel 814. As the vehicle 804-2 exits the tunnel 814, the navigation signals can be received again by the receiver in the vehicle 804-2.

In a third non-limiting example, a vehicle 804-3 is close to one or more tall buildings 812 in a dense urban environment. The one or more buildings 812 can block the direct reception of the navigation signals from the one or more satellites 808. As the vehicle 804-3 leaves the dense urban environment, the navigation signals can be received again by the receiver in the vehicle 804-3.

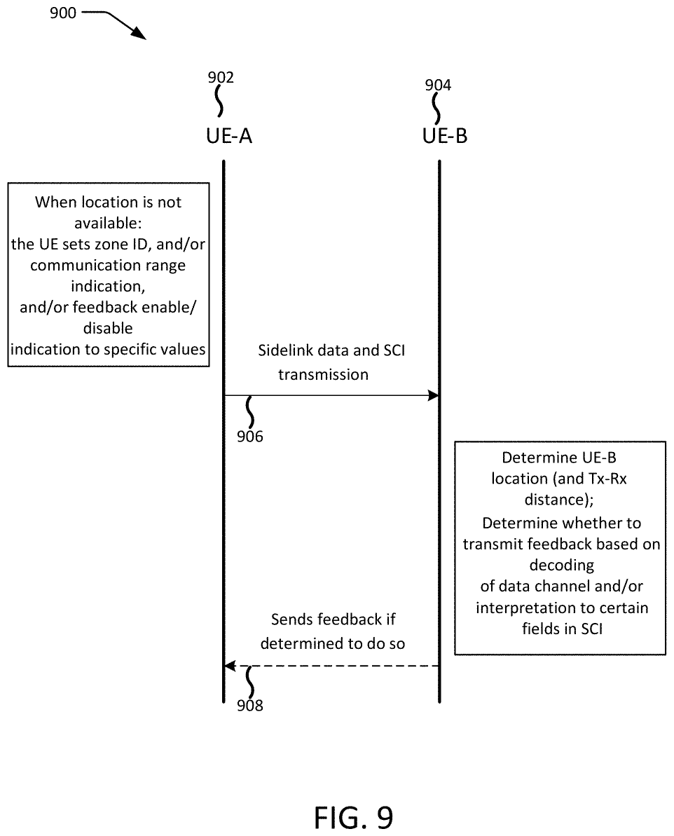

FIG. 9 illustrates a process flow 900 for triggering feedback responses in the absence of location information in V2X communications according to certain embodiments. In sidelink V2X communications, HARQ feedback may be needed to improve system performance. When HARQ feedback is employed, a first UE (e.g., UE-A 902) may send, at 906, data to a second UE (e.g., UE-B 904). The second UE can then send, at 908, a feedback message, such as an acknowledge (ACK) when the data is successful received or a negative-acknowledge (NACK) if the data is not received or is not successfully decoded.

According to the NR V2X protocol, a receiving (Rx) UE may send feedback when it is within a distance threshold from the transmitting UE. Specifically, NR-Release-16 V2X has a distance-based NACK-only feedback mode. In that mode, feedback is transmitted if the feedback is for NACK and the transmitter-receiver (Tx-Rx) distance is smaller than a distance threshold.

For distance-based HARQ feedback, the transmitter (Tx) UE location and distance threshold are generally signaled in the sidelink control information (SCI). The Tx UE location (e.g., geographical longitude and latitude (GLL) of the Tx UE) may generally be mapped to zone IDs, which can be indicated in SCI2. For example, a 12-bit parameter in SCI2 may be used to indicate the zone ID where the Tx UE is located. The 12-bit parameter may use six bits for longitudinal zones and six bits for latitudinal zones. Thus, 4096 zones (e.g., 64 (2\hat{ }6) longitudinal zones times 64 (2\hat{ }6) latitudinal zones) can be indicated by the 12-bit parameter.

The distance threshold for triggering the feedback may be a value in a predetermined or pre-defined set of values that are agreed upon. For example, the set of values may include nine values including {50, 80, 180, 200, 350, 400, 500, 700, 1000} meters. Therefore, the distance threshold may be indicated by a four-bit or five-bit parameter. For example, 16 (or 2\hat{ }4) different distance threshold values can be indicated by four bits. In one example, values 0-8 in the 4-bit parameter may indicate the distance threshold values 50, 80, 180, 200, 350, 400, 500, 700, and 1000 meters, respectively. The distance threshold for a sidelink data channel may be specified in, for example, 4-bit or 5-bit parameter for communication range indication in the SCI.

In one example, an Rx UE may determine the Tx-Rx distance between the Tx UE and the Rx UE based on, for example, the zone ID decoded from the SCI2 message transmitted by the Tx UE and a location of the Rx UE. The Rx UE may compare the Tx-Rx distance with the distance threshold specified in the SCI message (e.g., SCI2). The Rx UE may send a negative-acknowledgement (NACK) if it fails to decode the sidelink data channel from the Tx UE while the Tx-Rx distance is smaller than the distance threshold specified in the SCI message.

In some cases, the location information for the Tx UE and/or the Rx UE may not be available. Thus, the Rx UE may not be able to determine the Tx-Rx distance since the location or zone information is not available. For example, in some circumstances as described above with respect to FIG. 8, GNSS signals may not be available at the Tx UE or Rx UE due to blockages (e.g., in a tunnel or dense urban area). Thus, the location or zone ID of the Tx RE or the Rx UE may not be known. As such, the Rx UE may not determine the Tx-Rx distance to compare with the distance threshold to determine whether the distance-based (NACK-only) feedback message should be sent.

According to certain embodiments disclosed herein, various techniques may be employed to handle the distance-based sidelink feedback even if the location information is not available. In one example, the communication range indication in the SCI may be reused or reinterpreted to indicate that the location information of the Tx UE may not be available. As described above, in some embodiments of the V2X communication protocol, there may not be any unused values in the 12-bit zone ID parameter in the SCI2 message because all 4,096 (2\hat{ }12) values may be used to indicate the 4,096 zones. Therefore, the bits for the zone ID parameter may not be reused to imply the unavailability of the Tx UE location information. However, as also described above, there may be some unused values in the 4-bit or 5-bit parameter for communication range indication. In certain embodiments, these unused values in the parameter for communication range indication may be reserved and used to indicate the unavailability of the Tx UE location information.

As described above, the communication range indication (e.g., the distance threshold value) may be represented by an N-bit parameter, where N may be, for example, four or five. The parameter may have 2\hat{ }N possible values. Not all of the 2\hat{ }N values may be used for range indication. Therefore, at least one of the unused values can be used to indicate that the Tx UE location information is not available. For example, when four or five bits are used to indicate the communication range and there may only be about 9 agreed-upon range values, there can be seven (e.g., 2\hat{ }4−9=7) or more unused values in the 4-bit or 5-bit parameter. One of these seven unused values can be used by the Tx UE to indicate that the Tx location information is not available. For example, when the 4-bit parameter has any value from 9 to 15, which does not represent any one of the nine pre-defined distance threshold values, it may be determined that the Tx UE location information is not available. In one example, the parameter can be set to 2\hat{ }N−1 (e.g., 15) if the Tx UE location information is not available.

In another embodiment, the set of distance threshold values for triggering the feedback may include a distance threshold value to imply that the Tx UE location information is unavailable. For example, a zero-meter distance threshold value can be added to the set of distance threshold values such that the set of distance threshold values may include one value (e.g., zero meter) indicating that the Tx UE location information is unavailable. This additional distance threshold value may be represented by one of the 4-bit value, such as 0. The Tx UE may transmit a value “0” in the 4-bit communication range indication to indicate the zero-meter distance threshold value, and the Rx UE may infer from the zero-meter distance threshold value that the Tx UE location information is not available. In another non-limiting example, an unreasonably large distance threshold value (e.g., 5,000 meters) can be added to the set of distance threshold values to imply that the Tx UE location information is unavailable. The large distance threshold value may be represented by one of the 4-bit value, such as 14 or 15. The Tx UE may transmit a value “14” or “15” in the 4-bit communication range indication to indicate the 5000-meter distance threshold value, and the Rx UE may infer from the 5000-meter distance threshold value that the Tx UE location information is not available.

Thus, by defining additional values (e.g., 0 meter or 5000 meters) in the set of distance threshold values or using the unused values (e.g., 9 to 15) in the N-bit communication range indication to indicate that the Tx UE location information is unavailable, the Tx UE may indicate in the sidelink V2X message and the Rx UE may infer from the sidelink V2X message that the Tx UE location is not available. The Rx UE may then take actions accordingly to send or not to send the feedback message (e.g., the NACK message).

In some embodiments, a specific parameter may be used in the SCI field to indicate the availability of the Tx UE location information. For example, a new parameter can be defined in the SCI field to indicate whether the Tx UE location information is available or not. In one example, the SCI field can have a 1-bit parameter indicating whether the Tx UE location information is available. In a non-limiting example, a value zero (“0”) in the 1-bit parameter may indicate that the Tx UE location information is unavailable and a value one (“1”) in the 1-bit parameter may indicate that the Tx UE location information is available.

In some embodiments, the SCI field may be expanded to indicate the availability of the Tx UE location information. For example, the field of the parameter for feedback requirement indication may be expanded to indicate the availability of the Tx UE location information. In one non-limiting example, a 1-bit parameter may have been used in the SCI field to specify whether HARQ feedback is required or enabled (e.g., a value of “1” can indicate HARQ feedback is required or enabled, while a value of “0” can indicate that HARQ is disabled or not required). This 1-bit parameter for feedback requirement indication may be expanded to additionally indicate the availability of the Tx UE location information.

In one example, two or more bits may be used for both the HARQ feedback enable/disable indication and the Tx UE location availability indication. For example, a value of “00b” in a 2-bit parameter may indicate that feedback is not needed or required and the Tx UE location information is not available; a value “01b” in the 2-bit parameter may indicate that feedback is needed and the Tx UE location information is not available; a value “10b” may indicate that the Tx UE location information is available but the feedback is not needed; a value “11” may indicate that the Tx UE location information is available and the feedback is needed. Other combinations of the values and the corresponding indications are possible.

In this approach, the Tx UE may use an additional bit (used independently or in combination with other bits) in the SCI field to indicate whether the Tx UE location information is available, along with other indications. Thus, the Rx UE may know from the additional bit alone or in combination with other bits in the SCI field that the Tx UE location information is available or not, and may react accordingly to send or not to send the distance-based feedback message.

In some embodiments, no specific signaling of the unavailability of the Tx UE location information may be performed by the Tx UE, but the Rx UE may behave properly based on the sidelink control information. For example, if the Tx UE location information is unavailable, the Tx UE may indicate a relatively large distance threshold value (e.g., the largest value defined in the set of distance threshold values) in the communication range indication in the SCI. The Tx UE can also indicate a zone ID in the SCI. In some embodiments, the zone ID may be randomly selected by the Tx UE. In some embodiments, the indicated zone ID may be a specific zone ID (of a plurality of zone IDs) that is predetermined to be used when the Tx UE location information is not available. For example, a zone ID value of zero (“0”) may be used to indicate that the Tx UE location information is not available.

The Rx UE that receives the SCI indicating the zone ID and the communication range may or may not be aware of whether the Tx UE location information is not available. For example, if the zone ID indicated in the SCI is a specific zone that is predetermined to indicate that the Tx UE location information is unavailable, the Rx UE may know that the Tx UE location information is not available. If the zone ID indicated in the SCI is a randomly selected zone ID, the Rx UE may not know whether the Tx UE location information is not available. However, a large (e.g., the largest) distance threshold value specified in the communication range indication may ensure that mostly nearby Rx UEs would determine a Tx-Rx distance (e.g., based on the zone ID) that is less than the indicated distance threshold value and may send feedback (e.g., ACK or NACK) to the Tx UE accordingly.

Upon inferring that the Tx UE location information is unavailable, the Rx UE may react accordingly to send the appropriate feedback message. According to some embodiments, the Rx UE may send feedback based on the SCI indication. For example, when the SCI indicates that feedback is enabled or requested, the Rx UE may send feedback upon receiving the sidelink control information, without considering the Tx-Rx distance or regardless of the Tx-Rx distance.

According to some embodiments, upon inferring that the transmitter location is unavailable, the Rx UE may send feedback based on other measurements that can be used to determine a distance between a Tx UE and the Rx UE. For example, the Rx UE may measure the reference signal receive power (RSRP) to estimate the Tx-Rx distance. RSRP is the linear average over the power contributions (in watts) of the resource elements that carry cell-specific reference signals within the considered measurement frequency bandwidth. In other words, RSRP is the average power of the resource elements (REs) that carry cell-specific reference signals over the entire bandwidth. A higher RSRP indicates that the transmitter and receiver UEs are closer to each other. In some embodiments, the Rx UE may measure the RSRP of physical sidelink control channel (PSCCH)/demodulation reference signal (DMRS) of PSCCH, and send feedback only when the RSRP is larger than an RSRP threshold, which corresponds to a shorter Tx-Rx distance. SCI indication regarding the HARQ feedback may also be considered, and the Rx UE may not send the feedback if the HARQ feedback is disabled.

According to some embodiments, the Rx UE may determine whether to send the feedback based on the sidelink data channel priority. The sidelink data channel may have a certain priority value, where a higher (or lower) value may indicate a higher priority. For example, the basic safety messages (BSMs) may have a high priority for safety events and a lower priority for routine communications. The priority value of the data channel may be indicated in the SCI. The Rx UE may send the feedback when the data channel priority value indicated in the SCI is higher (or lower) than a priority threshold. In some embodiments, SCI indication regarding the HARQ feedback may also be considered, and the Rx UE may not send the feedback if the HARQ feedback is disabled.

According to some embodiments, the RX UE may send feedback based on the communication range indication. For example, in general, a larger distance threshold value may indicate that the Tx UE has a higher UE speed. Therefore, the Rx UE may send feedback to the Tx UE when the distance threshold value indicated in the communication range indication is larger than a threshold range (e.g., the longest or the second longest range in the set of pre-defined communication range). In some embodiments, SCI indication regarding the HARQ feedback may also be considered, and the Rx UE may not send the feedback if the HARQ feedback is disabled.

In some embodiments, when the Tx UE location information is not available, the Tx UE may set the zone ID field in the SCI to a specific value (e.g., 0) that is predetermined to indicate the lack of Tx UE location information. In some embodiments, the zone ID field in SCI may be mapped to a randomly selected value.

In some embodiments, when the Tx UE location information is not available, the Tx UE may always request feedback (e.g., enables the HARQ feedback), or may request feedback based on, for example, the data channel priority. Feedback may be enabled for data channels having higher priorities, such as data channels having priorities higher than a priority threshold.

In some embodiments, when the Rx UE location is not available (and thus it may be difficult to estimate the Tx-Rx distance), several techniques may be used to determine whether to send the feedback or not. For example, in one embodiment, the Rx UE may send the feedback only when the HARQ feedback is enabled in the SCI. In another embodiment, the Rx UE may send the feedback based at least in part on the communication range indication. For example, the Rx UE may send the feedback if the HARQ feedback is enabled and the distance threshold (communication range) value indicated in the communication range indication of the SCI is greater than a range threshold. In yet another embodiment, the Rx UE may send the feedback based on the RSRP measurement and an estimated Tx-Rx distance determined based on the RSRP measurement.

In one non-limiting implementation, when the Tx UE location information is not available, the Tx UE may indicate the lack of Tx UE location information by, for example, setting the zone ID in the SCI to zero or another predetermined value used to indicate that the Tx UE location information is unavailable, or setting the communication range indication to indicate a 0-meter distance threshold value. The Tx UE may also set the HARQ feedback enable/disable parameter to enable feedback. The Rx UE may know that the Tx UE location information is unavailable due to the 0-meter distance threshold value or the predetermined zone ID for indicating the unavailability of the TX UE location information, and may send the feedback if the HARQ feedback enable/disable parameter is set to enable feedback, without considering the Tx-Rx range.

In another implementation, when the Rx UE location is not available, the Rx UE may send feedback based at least in part on the feedback enable/disable indication in the SCI, without considering the Tx-Rx distance.

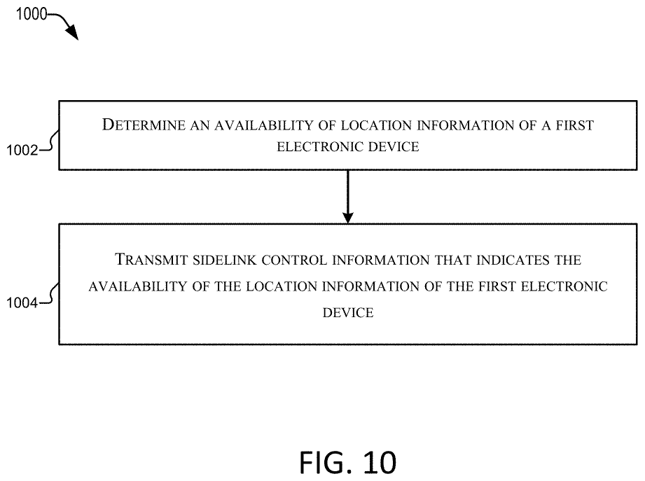

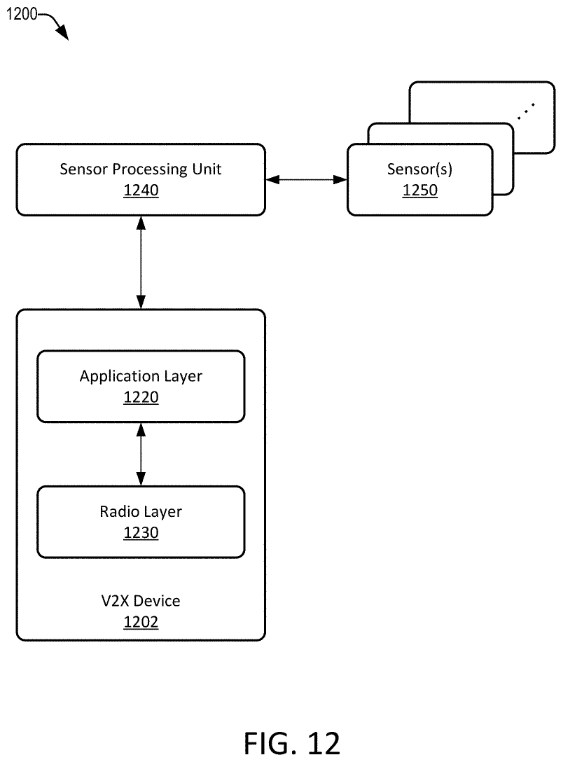

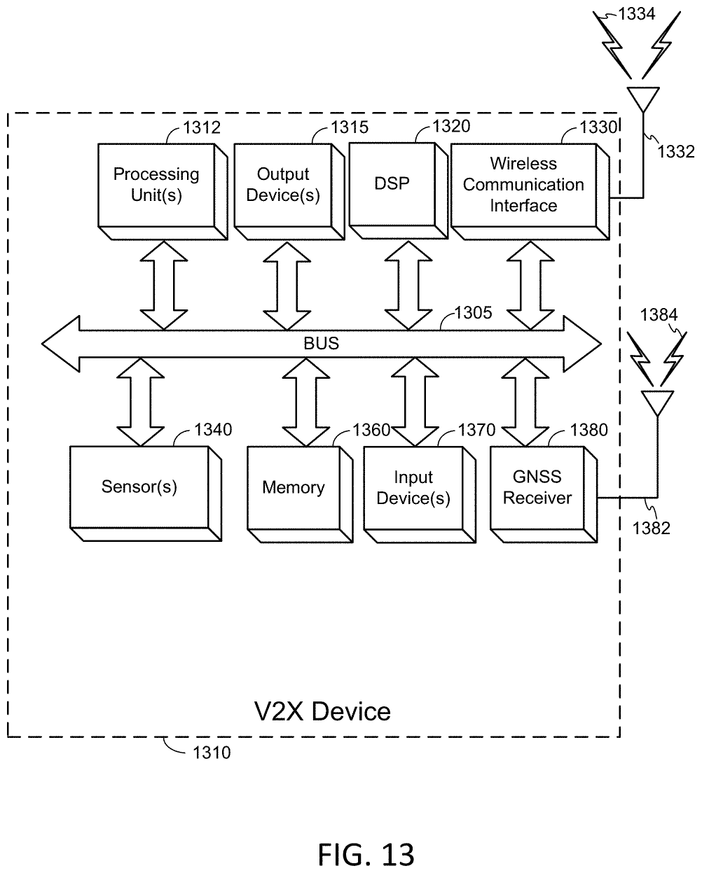

FIG. 10 includes a flow diagram 1000 illustrating a method for triggering distance-based V2X feedback responses in the absence of location data according to certain embodiments. Alternative embodiments may vary in function by combining, separating, or otherwise varying the operations described in the blocks illustrated in FIG. 10. Means for performing the operations of one or more of the blocks illustrated in FIG. 10 may include hardware and/or software components of a V2X device, such as V2X devices 1202 and 1310 illustrated in FIGS. 12 and 13 and described below. The V2X device may function as a transmitting V2X device (e.g., a Tx UE described above).

Operations in block 1002 may include determining an availability of location information of a first electronic device, such as a V2X-ccapable transmitting UE described above. For example, the navigation receiver of the first electronic device may detect a loss of satellite signals from one or more navigation satellites as describe above with respect to FIG. 8. In some embodiments, the loss of satellite signals may exceed a certain time threshold before the techniques are performed. Means for performing the operations in block 1002 may include, for example, a GNSS receiver 1380 of the V2X device 1310 illustrated in FIG. 13 and described below and/or or a navigation engine (e.g., implemented by processing unit(s) 1312).

Operation in block 1004 may include transmitting (e.g., by the first electronic device) sidelink control information that indicates the availability of the location information of the first electronic device. For example, a communication range indication of the sidelink control information can include a reserved value to indicate that the location information of the first electronic device is unavailable. In another example, a zero-meter range value can be added to a predetermined communication range set, and the communication range indication of the sidelink control information can include a value corresponding to the zero-meter range value to indicate that that the location information of the first electronic device is unavailable. In yet another example, a large range value that exceeds a maximum range value of a predetermined communication range set can be added to the communication range set, and the communication range indication of the sidelink control information can include a value corresponding to the large range value to indicate that that the location information of the first electronic device is unavailable.

According to some embodiments, the sidelink control information may include a communication range indication that indicates the availability of the location information of the first electronic device. The operations in the method may also include setting the communication range indication to a predetermined value based on determining that the location information of the first electronic device is unavailable. The predetermined value in the communication range indication may indicate a predetermined communication range (e.g., about 0 meter) that is lower than a first threshold value (e.g., <50 meters, such as <20 meters) or a predetermined communication range (e.g., about 5000 meters) that is greater than a second threshold value (e.g., >1000 meters, such as >2000 meters). Alternatively, the predetermined value may be a reserved value indicating that the location information of the first electronic device is unavailable. For example, the reserved value may not have a corresponding communication range in the predetermined communication range set and thus may not be interpreted as a range, but may instead indicate the unavailability of the location information of the first electronic device. In one illustrative example, the predetermined communication range set may include 9 predetermined communication ranges (e.g., distance threshold values for determining whether the transmitter-receiver distance is less than a specified distance threshold value such that a feedback message needs to be sent), such as 50, 80, 180, 200, 350, 400, 500, 700, and 1000 meters, which may be represented by values 0-8 in a 4-bit parameter for communication range indication. Therefore, values 9-15 in the 4-bit parameter for communication range indication may not be used to represent specific distance threshold values, and thus may be reserved for indicating that the location information of the first electronic device is unavailable.

In some embodiments, the sidelink control information may include one or more parameters indicating the availability of the location information of the first electronic device. For example, the one or more parameters may include a parameter (e.g., a 1-bit parameter) dedicated to indicating whether the location information of the first electronic device is available. In another example, the one or more parameters may include a parameter (e.g., a multi-bit parameter, such as a 2-bit parameter) that indicates whether the location information of the first electronic device is available and whether the distance-based feedback transmission is enabled or requested.

In some embodiments, the sidelink control information may include a communication range indication that indicates a long communication range (e.g., greater than a certain threshold range value), such as the longest or the second longest communication range in the predetermined communication range set, and may also include a randomly selected zone ID or a predetermined zone ID for indicating an unavailability of the location information of the first electronic device. In some embodiments, the sidelink control information may include a parameter indicating a priority of a sidelink data channel associated with the sidelink control information, a parameter indicating whether the distance-based feedback transmission is requested, or both.

Means for performing the operations in block 1004 may include, for example, processing unit(s) 1312, a memory 1360, a bus 1305, a DSP 1320, a wireless communication interface 1330, and a wireless communication antenna 1332 of the V2X device 1310 illustrated in FIG. 13 and described below.

It should be appreciated that the specific operations illustrated in FIG. 10 provide particular techniques for V2X communications according to various embodiments of the present disclosure. Other sequences of operations may also be performed according to alternative embodiments. For example, alternative embodiments of the present invention may perform the operations outlined above in a different order. Moreover, the individual operations illustrated in FIG. 10 may include multiple sub-operations that may be performed in various sequences as appropriate to the individual operations. Furthermore, additional operations may be added or removed depending on the particular applications. One of ordinary skill in the art would recognize many variations, modifications, and alternatives.

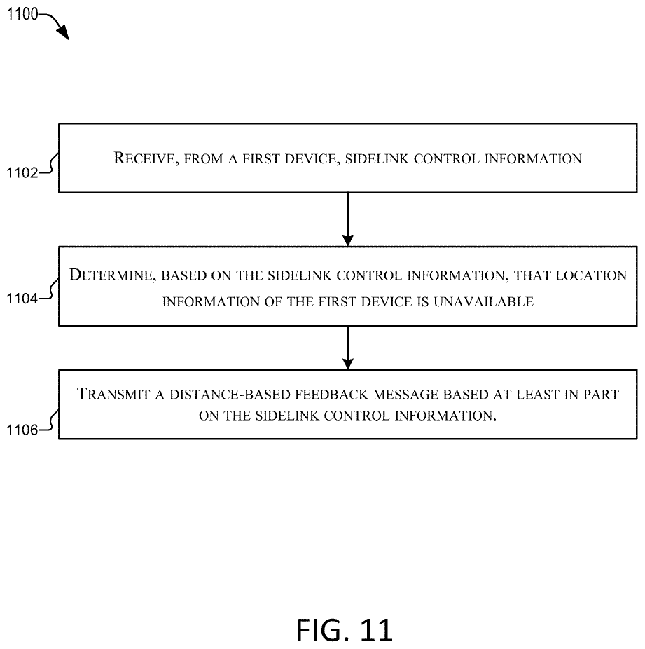

FIG. 11 includes a flow diagram 1100 illustrating a method for issuing feedback responses in the absence of location data according to certain embodiments. Alternative embodiments may vary in function by combining, separating, or otherwise varying the operations described in the blocks illustrated in FIG. 11. Means for performing the operations in one or more of the blocks illustrated in FIG. 11 may include hardware and/or software components of a V2X device, such as V2X devices 1202 and 1310 illustrated in FIGS. 12 and 13 and described below. The V2X device may function as a receiving V2X device (e.g., an Rx UE described above).

Operation in block 1102 may include receiving sidelink control information from a first device (e.g., a Tx UE) by a second device (e.g., an Rx UE). Means for performing the operations in block 1102 may include, for example, a processing unit(s) 1312, a memory 1360, a bus 1305, a DSP 1320, a wireless communication interface 1330, and a wireless communication antenna 1332 of the V2X device 1310 illustrated in FIG. 13 and described below.

Operations in block 1104 may include determining, based on the sidelink control information, that location information of the first device is unavailable. In some embodiments, determining that the location information of the first device is unavailable may include identifying, in the sidelink control information, a communication range indication including a predetermined value indicating that the location information of the first device is unavailable, a dedicated parameter indicating that the location information of the first device is unavailable, a parameter indicating that the location information of the first device is unavailable and that the distance-based feedback message is requested, a zone ID including a predetermined zone ID value indicating that the location information of the first device is unavailable, or any combination thereof. Means for performing the operations in block 1104 may include, for example, processing unit(s) 1312, a memory 1360, a bus 1305, and/or a DSP 1320 of V2X device 1310.

Operations in block 1106 may include transmitting, to the first device, a distance-based feedback message based at least in part on the sidelink control information. Means for performing the operations in block 1106 may include, for example, processing unit(s) 1312, a memory 1360, a bus 1305, a DSP 1320, a wireless communication interface 1330, and a wireless communication antenna 1332 of the V2X device 1310 illustrated in FIG. 13 and described below.

In some embodiments, the sidelink control information may indicate that the distance-based feedback message is requested, and the second device may transmit the distance-based feedback message regardless of the distance between the first device and the second device. In some embodiments, the operations in the method may include measuring an RSRP value of a reference signal from the first device, and transmitting the distance-based feedback message in response to at least one of the RSRP value exceeding an RSRP threshold value or the sidelink control information indicating that the distance-based feedback message is requested.

In some embodiments, the operations in the method may include determining, from the sidelink control information, a priority value of a sidelink data channel associated with the sidelink control information, and transmitting the distance-based feedback message in response to at least one of the priority value exceeding a priority threshold value or the sidelink control information indicating that the distance-based feedback message is requested. In some embodiments, the operations in the method may include determining, based on a communication range indication in the sidelink control information, a communication range of the first device, and transmitting the distance-based feedback message in response to at least one of the communication range exceeding a range threshold value or the sidelink control information indicating that the distance-based feedback message is requested.

It should be appreciated that the specific operations illustrated in FIG. 11 provide particular techniques for V2X communications according to various embodiments of the present disclosure. Other sequences of operations may also be performed according to alternative embodiments. For example, alternative embodiments of the present invention may perform the operations outlined above in a different order. Moreover, the individual operations illustrated in FIG. 11 may include multiple sub-operations that may be performed in various sequences as appropriate to the individual operations. Furthermore, additional operations may be added or removed depending on the particular applications. One of ordinary skill in the art would recognize many variations, modifications, and alternatives.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

FIG. 12 is a simplified block diagram of a basic architecture 1200 including components used for V2X communications according to certain embodiments. These components may include a V2X device 1202 with an application layer 1220 and radio layer 1230, a sensor processing unit 1240, and one or more sensors 1250. As a person of ordinary skill in the art will appreciate, the components illustrated in FIG. 12 may comprise hardware and/or software components and may be executed by different devices, as indicated below.

The V2X device 1202 may comprise a device or component used to obtain sensor information, determine an enhanced communication range based thereon, and transmit a V2X message having the enhanced communication range. As such, the V2X device 1202 may be located on a transmitting vehicle (e.g., UE 105 of FIG. 1, as previously described). That said, some embodiments may not be limited to vehicular V2X devices. And thus, the V2X device 1202 may comprise a non-vehicular, V2X-capable device (e.g., at a RSU, VRU, etc.).

The V2X device 1202 may comprise hardware and software components, such as those illustrated in FIG. 13 and described below. These components include components capable of executing the application layer 1220 and radio layer 1230 shown in FIG. 12. For example, the application layer may be implemented by a software application executed by processing unit(s) and memory of the V2X device 1202, and is the radio layer 1230 may be implemented by software (e.g., firmware) executed at a wireless communication interface (e.g., transceiver) of the V2X device.

In short, the application layer 1220 may be the layer at which the sensor-based communication range may be determined, based on input from the sensor(s) 1250 (e.g., comprising a camera, radar, LIDAR, etc.), which is provided via the sensor processing unit 1240. The sensor processing unit 1240 may comprise a general- or special-purpose processor that acts as a central hub for sensor data by receiving and processing sensor data from the sensor(s) 1250. In some embodiments, for example, the sensor processing unit 1240 may be capable of receiving and fusing sensor data from the sensor(s) 1250 to determine higher-order information. And thus, in some embodiments, the sensor processing unit 1240 can provide the application layer 1220 of the V2X device 1202 with one or more properties of an object detected by the sensor(s) 1250 (object type, location, velocity, acceleration, etc.). Additionally or alternatively, raw sensor data may be provided to the V2X device 1202, which may make this determination. In some embodiments, therefore, the functionality of the sensor processing unit 1240 may be integrated into the V2X device 1202. In some embodiments, as noted, the sensor(s) 1250 may be located on a vehicle or device separate from the V2X device 1202. In some embodiments, the sensor processing unit 1240, too, can be located on a separate vehicle or device. In such instances, communication between the sensor(s) 1250 and sensor processing unit 1240, and/or communication between the sensor processing unit 1240 and V2X device 1202 may be via wireless communication means.

The application layer 1220 acts as an intermediary between the radio layer 1230 and is the sensor(s) 1250. As noted, it can determine, based on sensor data as provided via the sensor processing unit 1240, the communication range for a V2X message sent from the V2X device 1202 via the radio layer 1230. At the radio layer 1230, which comprises the physical layer of hardware and software components configured to transmit the V2X message, the determined communication range can be implemented as a Hybrid Automatic Repeat Request (HARQ) feedback distance based on the desired range. As a person of ordinary skill in the art will appreciate, a parameter indicative of the HARQ feedback distance may be included in the V2X message itself; or, the parameter indicative of HARQ feedback distance may be included in signaling accompanying or indicating the V2X message, e.g., sidelink control information. Thus, in some embodiments, the determined communication range may be implemented by including, in the V2X message or corresponding signaling, a parameter indicative of the HARQ feedback distance.

It is noted, however, that the HARQ feedback distance may not be the same as the determined communication range. In some embodiments, for example, the HARQ feedback distance may be slightly larger than the determined communication range to accommodate some margin. Accordingly, some embodiments may utilize techniques for converting or mapping a determined communication range to a HARQ feedback distance. These can include, increasing the determined communication range by a certain percentage or minimum distance, for example. In another example, the indication of HARQ feedback distance has limitation (e.g., only a limited number of quantized distances can be indicated); the determined communication range is mapped to one of the quantized distances.

According to some embodiments, the radio layer 1230 may also be used to determine an appropriate Modulation and Coding Scheme (MC S), based on the communication range determined by the application layer 1220 and passed to the radio layer. As a person of ordinary skill in the art will appreciate, the radio layer 1230 may use different orders of MCS for transmitting the V2X message. Generally put, more elaborate coding schemes (higher orders of MCS) may be used at shorter ranges, whereas more basic coding schemes are used if the desired ranges longer. Proper MCS selection can be used to help ensure efficient spectrum usage.

FIG. 13 is a block diagram of an example of a V2X device 1310, which may be utilized to perform the operations and implement the techniques described herein. In some embodiments, the V2X device 1310 may include or may be integrated into a vehicle computer system used to manage one or more systems related to the vehicle's navigation and/or automated driving, as well as communicate with other onboard systems and/or other traffic entities. In some embodiments, the V2X device 1310 may comprise a stand-alone device or component on a vehicle (or other V2X entity), which may be communicatively coupled with other components/devices of the vehicle (or entity).

As noted, the V2X device 1310 may implement the application layer 1220 and radio layer 1230 illustrated in FIG. 12, and may also perform one or more of the functions of flow diagram 1000 of FIG. 10 and flow diagram 1100 of FIG. 11, previously described. It should be noted that FIG. 13 is meant only to provide a generalized illustration of various components, any or all of which may be utilized as appropriate. It can be noted that, in some instances, components illustrated by FIG. 13 can be localized to a single physical device and/or distributed among various networked devices, which may be located, for example, at different physical locations on a vehicle.

The V2X device 1310 is shown comprising hardware elements that can be electrically coupled via a bus 1305 (or may otherwise be in communication, as appropriate). The hardware elements may include processing unit(s) 1312 which can include without limitation one or more general-purpose processors, one or more special-purpose processors (such as digital signal processing (DSP) chips, graphics acceleration processors, application-specific integrated circuits (ASICs), and/or the like), and/or other processing structure or means. As shown in FIG. 13, some embodiments may have a separate Digital Signal Processor (DSP) 1320, depending on desired functionality. In embodiments where a sensor processing unit 1240 (as illustrated in FIG. 12 and previously described) is integrated into the V2X device 1310, the processing unit(s) 1312 may comprise the sensor processing unit 1240.

The V2X device 1310 also can include one or more input devices 1370, which can include devices related to user interface (e.g., a touch screen, touchpad, microphone, button(s), dial(s), switch(es), and/or the like) and/or devices related to navigation, automated driving, and the like. Similarly, the one or more output devices 1315 may be related to interacting with a user (e.g., via a display, light emitting diode(s) (LED(s)), speaker(s), etc.), and/or devices related to navigation, automated driving, and the like.

The V2X device 1310 may also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device and/or various cellular devices, etc.), and/or the like. The wireless communication interface 1330 can enable the V2X device 1310 to communicate to other V2X devices, and (as previously noted) may be used to implement the radio layer 1230 illustrated in FIG. 12 and described above, to transmit a V2X message with a determined communication range. Communication using the wireless communication interface 1330 can be carried out via one or more wireless communication antenna(s) 1332 that send and/or receive wireless signals 1334.

The V2X device 1310 can further include sensor(s) 1340. Sensors 1340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like). Sensors 1340 may be used, for example, to determine certain real-time characteristics of the vehicle, such as location, velocity, acceleration, and the like. The sensor(s) 1340 illustrated in FIG. 13 may include sensor(s) 1250 (as illustrated in FIG. 12 and previously described), in instances where sensor data used to detect an object is received from sensors that are co-located on a vehicle (or other V2X entity) with the V2X device 1310.

Embodiments of the V2X device 1310 may also include a GNSS receiver 1380 capable of receiving signals 1384 from one or more GNSS satellites using an antenna 1382 (which could be the same as wireless communication antenna 1332). Positioning based on GNSS signal measurement can be utilized to determine a current location of the V2X device, and may further be used as a basis to determine the location of a detected object. The GNSS receiver 1380 can extract a position of the V2X device 1310, using conventional techniques, from GNSS satellites of a GNSS system, such as Global Positioning System (GPS) and/or similar satellite systems.

The V2X device 1310 may further comprise and/or be in communication with a memory 1360. The memory 1360 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the V2X device 1310 also can comprise software elements (not shown in FIG. 13), including an operating system, device drivers, executable libraries, and/or other code, such as one or more application programs, which may comprise computer programs provided by various embodiments, and/or may be designed to implement methods and/or configure systems as described herein. Software applications stored in memory 1360 and executed by processing unit(s) 1312 may be used to implement the application layer 1220 illustrated in FIG. 12 and previously described. Moreover, one or more procedures described with respect to the method(s) discussed herein may be implemented as code and/or instructions in memory 1360 that are executable by the V2X device 1310 (and/or processing unit(s) 1312 or DSP 1320 within V2X device 1310), including the functions illustrated in flow diagrams 1000 and 1100 of FIGS. 10 and 11 as described above. In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, RAM, a programmable ROM (PROM), erasable programmable ROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. In addition, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special-purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special-purpose computer or similar special-purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. In addition, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. A method of triggering a distance-based feedback transmission in a vehicle communication system, the method comprising:
determining an availability of location information of a first electronic device; and
transmitting sidelink control information that indicates the availability of the location information of the first electronic device.
   Clause 2. The method of clause 1, wherein the sidelink control information includes a communication range indication that indicates the availability of the location information of the first electronic device.
   Clause 3. The method of clause 2, further comprising setting the communication range indication to a predetermined value based on determining that the location information of the first electronic device is unavailable.
   Clause 4. The method of clause 3, wherein the predetermined value indicates a predetermined communication range that is lower than a first threshold value or greater than a second threshold value.
   Clause 5. The method of clause 3, wherein the predetermined value is a reserved value indicating that the location information of the first electronic device is unavailable.
   Clause 6. The method of clause 1, wherein the sidelink control information includes one or more parameters indicating the availability of the location information of the first electronic device.
   Clause 7. The method of clause 6, wherein the one or more parameters include a parameter dedicated to indicating whether the location information of the first electronic device is available.
   Clause 8. The method of clause 6, wherein the one or more parameters include a parameter that indicates whether the location information of the first electronic device is available and whether the distance-based feedback transmission is enabled.
   Clause 9. The method of clause 1, wherein the sidelink control information includes:
a communication range indication that indicates a communication range greater than a threshold range value; and
a randomly selected zone identification (ID) or a predetermined zone ID for indicating an unavailability of the location information of the first electronic device.
   Clause 10. The method of clause 1, wherein the sidelink control information includes at least one of:
a parameter indicating a priority of a sidelink data channel associated with the sidelink control information; or
a parameter indicating whether the distance-based feedback transmission is requested.
   Clause 11. A method comprising:
receiving, from a first device, sidelink control information by a second device;
determining, based on the sidelink control information, that location information of the first device is unavailable; and
transmitting, to the first device, a distance-based feedback message based at least in part on the sidelink control information.
   Clause 12. The method of clause 11, wherein the sidelink control information indicates that the distance-based feedback message is requested regardless of a distance between the first device and the second device.
   Clause 13. The method of any of clauses 11 and 12, further comprising:
measuring a refence signal received power (RSRP) value of a reference signal from the first device; and
transmitting the distance-based feedback message in response to at least one of:
   the RSRP value exceeding an RSRP threshold value; or
   the sidelink control information indicating that the distance-based feedback message is requested.
      Clause 14. The method of any of clauses 11 and 12, further comprising:
determining, from the sidelink control information, a priority value of a sidelink data channel associated with the sidelink control information; and
transmitting the distance-based feedback message in response to at least one of:
   the priority value exceeding a priority threshold value; or
   the sidelink control information indicating that the distance-based feedback message is requested.
      Clause 15. The method of any of clauses 11 and 12, further comprising:
determining, based on a communication range indication in the sidelink control information, a communication range of the first device; and
transmitting the distance-based feedback message in response to at least one of:
   the communication range exceeding a range threshold value; or
   the sidelink control information indicating that the distance-based feedback message is requested.
      Clause 16. The method of any of clauses 11-15, wherein determining, based on the sidelink control information, that the location information of the first device is unavailable comprises identifying, in the sidelink control information, at least one of:
a communication range indication including a predetermined value indicating that the location information of the first device is unavailable;
a dedicated parameter indicating that the location information of the first device is unavailable;
a parameter indicating that the location information of the first device is unavailable and that the distance-based feedback message is requested; or
a zone identification (ID) including a predetermined zone ID value indicating that the location information of the first device is unavailable.
   Clause 17. A vehicle-to-everything (V2X) device comprising:
a transceiver;
a memory; and
one or more processing units communicatively coupled with the transceiver and the memory and configured to:
   determine an availability of location information of the V2X device; and
   transmit, via the transceiver, sidelink control information that indicates the availability of the location information of the V2X device.
      Clause 18. The V2X device of clause 17, wherein the one or more processing units are configured to, based on determining that the location information of the V2X device is unavailable, set a communication range indication in the sidelink control information to a predetermined value.
      Clause 19. The V2X device of clause 18, wherein:
the predetermined value indicates a predetermined communication range that is lower than a first threshold value or greater than a second threshold value, the first threshold value lower than the second threshold value; or
the predetermined value is a reserved value indicating that the location information of the V2X device is unavailable.
   Clause 20. The V2X device of clause 17, wherein the sidelink control information includes one or more parameters indicating the availability of the location information of the V2X device.
   Clause 21. The V2X device of clause 20, wherein the one or more parameters include a parameter dedicated to indicating whether the location information of the V2X device is available.
   Clause 22. The V2X device of clause 20, wherein the one or more parameters include a parameter that indicates whether the location information of the V2X device is available and whether a distance-based feedback transmission is enabled.
   Clause 23. The V2X device of clause 17, wherein the sidelink control information includes:
a communication range indication that indicates a communication range greater than a threshold range value; and
a randomly selected zone identification (ID) or a predetermined zone ID for indicating an unavailability of the location information of the V2X device.
   Clause 24. The V2X device of clause 17, wherein the sidelink control information includes at least one of:
a parameter indicating a priority of a sidelink data channel associated with the sidelink control information; or
a parameter indicating whether a distance-based feedback transmission is requested.
   Clause 25. A vehicle-to-everything (V2X) device comprising:
a transceiver;
a memory; and
one or more processing units communicatively coupled with the transceiver and the memory and configured to:
   receive, via the transceiver, sidelink control information from a first electronic device;
   determine, based on the sidelink control information, that location information of the first electronic device is unavailable; and
   transmit, to the first electronic device via the transceiver, a distance-based feedback message based at least in part on the sidelink control information.
      Clause 26. The V2X device of clause 25, wherein the sidelink control information indicates that the distance-based feedback message is requested regardless of a distance between the first electronic device and the V2X device.
      Clause 27. The V2X device of any of clauses 25 and 26, wherein the one or more processing units are configured to:
measure, via the transceiver, a refence signal received power (RSRP) value of a reference signal from the first electronic device; and
transmit, via the transceiver, the distance-based feedback message in response to at least one of:
   the RSRP value exceeding an RSRP threshold value; or
   the sidelink control information indicating that the distance-based feedback message is requested.
      Clause 28. The V2X device of any of clauses 25 and 26, wherein the one or more processing units are configured to:
determine, from the sidelink control information, a priority value of a sidelink data channel associated with the sidelink control information; and
transmit, via the transceiver, the distance-based feedback message in response to at least one of:
   the priority value exceeding a priority threshold value; or
   the sidelink control information indicating that the distance-based feedback message is requested.
      Clause 29. The V2X device of any of clauses 25 and 26, wherein the one or more processing units are configured to:
determine, based on a communication range indication in the sidelink control information, a communication range of the first electronic device; and
transmit, via the transceiver, the distance-based feedback message in response to at least one of:
   the communication range exceeding a range threshold value; or
   the sidelink control information indicating that the distance-based feedback message is requested.
      Clause 30. The V2X device of any of clauses 25-29, wherein determining, based on the sidelink control information, that the location information of the first electronic device is unavailable comprises identifying, in the sidelink control information, at least one of:
a communication range indication including a predetermined value indicating that the location information of the first electronic device is unavailable;
a dedicated parameter indicating that the location information of the first electronic device is unavailable;
a parameter indicating that the location information of the first electronic device is unavailable and that the distance-based feedback message is requested; or
a zone identification (ID) including a predetermined zone ID value indicating that the location information of the first electronic device is unavailable.

What is claimed is:

1. A method of triggering a distance-based feedback transmission in a vehicle communication system, the method comprising:
determining an availability of location information of a first electronic device; and
transmitting sidelink control information that indicates the availability of the location information of the first electronic device.

2. The method of claim 1, wherein the sidelink control information includes a communication range indication that indicates the availability of the location information of the first electronic device.

3. The method of claim 2, further comprising setting the communication range indication to a predetermined value based on determining that the location information of the first electronic device is unavailable.

4. The method of claim 3, wherein the predetermined value indicates a predetermined communication range that is lower than a first threshold value or greater than a second threshold value.

5. The method of claim 3, wherein the predetermined value is a reserved value indicating that the location information of the first electronic device is unavailable.

6. The method of claim 1, wherein the sidelink control information includes one or more parameters indicating the availability of the location information of the first electronic device.

7. The method of claim 6, wherein the one or more parameters include a parameter dedicated to indicating whether the location information of the first electronic device is available.

8. The method of claim 6, wherein the one or more parameters include a parameter that indicates whether the location information of the first electronic device is available and whether the distance-based feedback transmission is enabled.

9. The method of claim 1, wherein the sidelink control information includes:
a communication range indication that indicates a communication range greater than a threshold range value; and
a randomly selected zone identification (ID) or a predetermined zone ID for indicating an unavailability of the location information of the first electronic device.

10. The method of claim 1, wherein the sidelink control information includes at least one of:
a parameter indicating a priority of a sidelink data channel associated with the sidelink control information; or
a parameter indicating whether the distance-based feedback transmission is requested.

11. A method comprising:
receiving, from a first device, sidelink control information by a second device;
determining, based on the sidelink control information, that location information of the first device is unavailable; and
transmitting, to the first device, a distance-based feedback message based at least in part on the sidelink control information.

12. The method of claim 11, wherein the sidelink control information indicates that the distance-based feedback message is requested regardless of a distance between the first device and the second device.

13. The method of claim 11, further comprising:
measuring a refence signal received power (RSRP) value of a reference signal from the first device; and
transmitting the distance-based feedback message in response to at least one of:
the RSRP value exceeding an RSRP threshold value; or
the sidelink control information indicating that the distance-based feedback message is requested.

14. The method of claim 11, further comprising:
determining, from the sidelink control information, a priority value of a sidelink data channel associated with the sidelink control information; and
transmitting the distance-based feedback message in response to at least one of:
the priority value exceeding a priority threshold value; or
the sidelink control information indicating that the distance-based feedback message is requested.

15. The method of claim 11, further comprising:
determining, based on a communication range indication in the sidelink control information, a communication range of the first device; and
transmitting the distance-based feedback message in response to at least one of:
the communication range exceeding a range threshold value; or
the sidelink control information indicating that the distance-based feedback message is requested.

16. The method of claim 11, wherein determining, based on the sidelink control information, that the location information of the first device is unavailable comprises identifying, in the sidelink control information, at least one of:
a communication range indication including a predetermined value indicating that the location information of the first device is unavailable;
a dedicated parameter indicating that the location information of the first device is unavailable;
a parameter indicating that the location information of the first device is unavailable and that the distance-based feedback message is requested; or
a zone identification (ID) including a predetermined zone ID value indicating that the location information of the first device is unavailable.

17. A vehicle-to-everything (V2X) device comprising:
a transceiver;
a memory; and
one or more processing units communicatively coupled with the transceiver and the memory and configured to:
determine an availability of location information of the V2X device; and
transmit, via the transceiver, sidelink control information that indicates the availability of the location information of the V2X device.

18. The V2X device of claim 17, wherein the one or more processing units are configured to, based on determining that the location information of the V2X device is unavailable, set a communication range indication in the sidelink control information to a predetermined value.

19. The V2X device of claim 18, wherein:
the predetermined value indicates a predetermined communication range that is lower than a first threshold value or greater than a second threshold value, the first threshold value lower than the second threshold value; or
the predetermined value is a reserved value indicating that the location information of the V2X device is unavailable.

20. The V2X device of claim 17, wherein the sidelink control information includes one or more parameters indicating the availability of the location information of the V2X device.

21. The V2X device of claim 20, wherein the one or more parameters include a parameter dedicated to indicating whether the location information of the V2X device is available.

22. The V2X device of claim 20, wherein the one or more parameters include a parameter that indicates whether the location information of the V2X device is available and whether a distance-based feedback transmission is enabled.

23. The V2X device of claim 17, wherein the sidelink control information includes:
a communication range indication that indicates a communication range greater than a threshold range value; and
a randomly selected zone identification (ID) or a predetermined zone ID for indicating an unavailability of the location information of the V2X device.

24. The V2X device of claim 17, wherein the sidelink control information includes at least one of:
a parameter indicating a priority of a sidelink data channel associated with the sidelink control information; or
a parameter indicating whether a distance-based feedback transmission is requested.

25. A vehicle-to-everything (V2X) device comprising:
a transceiver;
a memory; and
one or more processing units communicatively coupled with the transceiver and the memory and configured to:
receive, via the transceiver, sidelink control information from a first electronic device;
determine, based on the sidelink control information, that location information of the first electronic device is unavailable; and
transmit, to the first electronic device via the transceiver, a distance-based feedback message based at least in part on the sidelink control information.

26. The V2X device of claim 25, wherein the sidelink control information indicates that the distance-based feedback message is requested regardless of a distance between the first electronic device and the V2X device.

27. The V2X device of claim 25, wherein the one or more processing units are configured to:
measure, via the transceiver, a refence signal received power (RSRP) value of a reference signal from the first electronic device; and
transmit, via the transceiver, the distance-based feedback message in response to at least one of:
the RSRP value exceeding an RSRP threshold value; or
the sidelink control information indicating that the distance-based feedback message is requested.

28. The V2X device of claim 25, wherein the one or more processing units are configured to:
determine, from the sidelink control information, a priority value of a sidelink data channel associated with the sidelink control information; and
transmit, via the transceiver, the distance-based feedback message in response to at least one of:
the priority value exceeding a priority threshold value; or
the sidelink control information indicating that the distance-based feedback message is requested.

29. The V2X device of claim 25, wherein the one or more processing units are configured to:
determine, based on a communication range indication in the sidelink control information, a communication range of the first electronic device; and
transmit, via the transceiver, the distance-based feedback message in response to at least one of:
the communication range exceeding a range threshold value; or
the sidelink control information indicating that the distance-based feedback message is requested.

30. The V2X device of claim 25, wherein determining, based on the sidelink control information, that the location information of the first electronic device is unavailable comprises identifying, in the sidelink control information, at least one of:
a communication range indication including a predetermined value indicating that the location information of the first electronic device is unavailable;
a dedicated parameter indicating that the location information of the first electronic device is unavailable;
a parameter indicating that the location information of the first electronic device is unavailable and that the distance-based feedback message is requested; or
a zone identification (ID) including a predetermined zone ID value indicating that the location information of the first electronic device is unavailable.
